(19) United States
(12) Patent Application Publication
(10) Pub. No.: US 2010/0298504 A1
(43) Pub. Date: Nov. 25, 2010

(54) AMPHIPHILIC POLYMER AND PROCESSES OF FORMING THE SAME

(75) Inventors: Dominik Janczewski, Singapore (SG); Nikodem Tomczak, Singapore (SG); Yin Win Khin, Singapore (SG); Mingyong Han, Singapore (SG); Julius Vancso, Singapore (SG)

Correspondence Address: SEED INTELLECTUAL PROPERTY LAW GROUP PLLC, 701 FIFTH AVE, SUITE 5400, SEATTLE, WA, 98104, US

(73) Assignee: AGENCY FOR SCIENCE, TECHNOLOGY AND RESEARCH, Singapore (SG)

(21) Appl. No.: 12/678,734

(22) PCT Filed: Sep. 19, 2008
(86) PCT No.: PCT/SG2008/000356

§ 371 Date: Aug. 13, 2010

Related U.S. Application Data
(60) Provisional application No. 60/973,619, filed on Sep. 19, 2007.

(51) Int. Cl. C08G 63/91; C08G 63/00

(52) U.S. Cl. 525/418; 528/327; 977/773

(57) ABSTRACT

Disclosed are an amphiphilic polymer, its synthesis and uses thereof. The polymer has a hydrocarbon backbone with —COOH side groups. It further has first aliphatic moieties with a main chain of about 3 to about 20 carbon atoms and 0 to about 3 heteroatoms, and second aliphatic moieties that have a main chain of about 3 to about 80 carbon atoms and about 2 to about 40 heteroatoms. The second aliphatic moieties have a copolymerisable group. In the synthesis a maleic anhydride polymer of formula (I) where n is an integer from about 10 to about 10000 and R1 is H or methyl, is reacted with a monofunctional compound with an alkyl chain of about 3 to about 20 carbon atoms and 0 to about 2 heteroatoms, and with an at least bifunctional compound with an alkyl chain of about 3 to about 80 carbon atoms and 0 to about 40 heteroatoms. The functional group of the monofunctional compound and one functional group of the at least bifunctional compound can form a linkage with an anhydride. Another functional group of the at least bifunctional compound, which is not allowed to react with the maleic anhydride polymer, is copolymerisable.

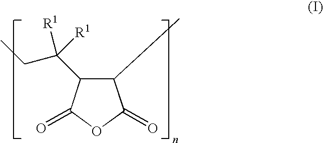

### CROSS-REFERENCE TO RELATED APPLICATIONS

This application makes reference to and claims the benefit of priority of an application for a “Versatile platform for coating, solubilization and functionalization of nanoparticles” filed on Sept. 19, 2007 with the United States Patent and Trademark Office, and there duly assigned Ser. No. 60/973,619. The contents of said application filed on Sept. 19, 2007 is incorporated herein by reference for all purposes, including an incorporation of any element or part of the description, claims or drawings not contained herein and referred to in Rule 20.5(a) of the PCT, pursuant to Rule 4.18 of the PCT.

### FIELD OF THE INVENTION

The present invention provides an amphiphilic polymer and processes of forming the same. Also provided are methods of forming a water-soluble nanocrystal using the amphiphilic polymer as well as a corresponding water-soluble nanocrystal and uses thereof.

### BACKGROUND OF THE INVENTION

Highly luminescent semiconductor nanocrystals, usually referred to as quantum dots (QDs) with their unique size/composition-tunable narrow emission and broad absorption spectra have drawn great attention in the last decade due to their promising application in optoelectronics and biology. These applications range from solar cells, light emitting diodes, laser technologies, and chemical sensing to bio-imaging.

Preparation of high-quality quantum dots is in many cases performed at elevated temperatures in the presence of tri-n-octyl phosphine oxide (TOPO) as the stabilizing ligand. As a result the nanoparticles are coated with a monolayer of TOPO, a hydrophobic molecule, and the QDs are solvable in non-polar solvents and do not disperse in aqueous solutions. Exchanging the TOPO ligands at the QD surface usually greatly affects the QD luminescent properties, decreasing in many cases the overall luminescence quantum yields. The control over the amount of the functional groups on the QD surface and the stability of the resulting monolayer coating was found to be limited. In many cases one would wish to obtain QDs with multiple functionalities present at the QD surface. Exchanging the TOPO ligand with several different ligands is problematic. Different affinities of the ligands to the QD surface but mostly the intermolecular interaction between different ligands prevent one to obtain e.g. zwitterionic QDs. Short molecular ligands on the surface of semiconductor nanocrystals are also a weak barrier for chemical and photochemical degradation processes and therefore such ligand-coated QDs can have health and environmental risks.

Recently, a number of effective approaches for synthesizing high-quality hydrophobic QDs have been reported and some new methods for transforming the hydrophobic QDs into hydrophilic via surface modification have consequently been developed for various bio-applications. Currently, the most popular way to render QDs water-soluble encompasses a direct exchange of the hydrophobic surface coating ligands (long alkyl chains) with small bi-functional organic ligands. Alternatively, hydrophobic QDs have also been solubilised in water by using amphiphilic molecules through hydrophobic-hydrophobic interaction with hydrophobic ligands on the surface of QDs, such as hydrophobic TOPO. Small molecules such as phospholipids, calixarenes, cyclodextrines, as well as complex copolymers (in particular the polyacrylic acid derivatives) have been used for this purpose. Important advantages of this approach include the omission of the ligand exchange step and the easy introduction of functionality without affecting the surface of QDs, which could result in deterioration of their optical properties.

Exploitation of the noncovalent hydrophobic interactions as a means to coat the QDs is a solution for some of the listed problems but currently available technologies does not allow one to solve all the problems with one particular coating.

In the first report on the modification of QD with polymers using hydrophobic interactions Dubertret et al. (Science (2002) 298, 1759) have encapsulated the QDs in the hydrophobic core of a micelle composed of a mixture of 40% 1,2-dipalmitoyl-sn-glycero-3-phosphoethanolamine-N-[methoxy(polyethylene glycol)-2000] and 60% of 1,2-dipalmitoyl-sn-glycero-3-phosphocholine. The micelles provided a hydrophobic interface for the nanoparticles and maintain high colloidal stability. The amine functionalized polyethylene glycol (PEG) could be further used to couple biomacromolecules. The presence of PEG layer was a prerequisite to solubilize the QD. The method is not suitable to obtain versatile QD surface chemistry without the PEG coating.

Different approaches, relying not on a polymer micelle formation but rather on the direct coating of the QDs with amphiphilic polymers were later developed. Amphiphilic, alkyl modified (octylamine or isopropylamine) low molecular weight polyacrylic acids were successfully shown to coat TOPO-protected nanocrystals and solubilize the QDs in water (Wu, X., et al., Nat. Biotechnol. (2003) 21, 41; Mattheakis, L. C., et al., Anal. Biochem. (2004) 327, 200; Luccardini C., et al., Langmuir (2006) 22, 2304). In a recent study Luccardini et al. (ibid.) have reported on the pH dependent interactions of the coated QDs with lipid membranes. They found that in biological buffers the interaction between the polymer coated QD and the membrane can be controlled by the pH of the buffer. In the work of Gao et al. high molecular mass amphiphilic ABC triblock copolymers consisting of a polybutylacrylate part (hydrophobic), polyethylacrylate part (hydrophobic), and polymethacrylic acid part (hydrophilic), were used to directly encapsulate QDs (Gao X., et al., Nat. Biotechnol. (2004) 22, 969).

Hydrophobic hydrocarbon side chains and amine terminated PEG were used to derivatize the methacrylic acid.

Although the above listed methods based on amphiphilic polymer solubilize the QD further functionalization or derivatization of the QD surface has to be performed using coupling agents in presence of QDs. This is usually undesirable since it involves unnecessary additional work and may lead to luminescence quenching.

A different class of polymers used to transfer hydrophobic QDs directly into water is poly(maleic anhydride alt-1-tetradecene) (Pellegrino, T., et al., Nano Lett. (2004) 4, 703; Yu, W. W., et al., J. Am. Chem. Soc. (2007) 129, 2871). The stability of the polymer shell was increased by addition of the bis(6-aminohexyl)amine crosslinker. One disadvantage of the present approach is the fixed number of hydrophobic chains and carboxyl groups. Chemical derivatization with e.g. PEG polymer chains is also performed via coupling agents.

Accordingly, it is an object of the present invention to provide an amphiphilic polymer as well as a process of forming the same with properties that overcome at least some of the above discussed disadvantages.

### SUMMARY OF THE INVENTION

According to a first aspect, the invention provides a process of forming an amphiphilic polymer. The amphiphilic polymer includes a hydrocarbon backbone. The hydrocarbon backbone of the amphiphilic polymer carries —COOH side groups. The hydrocarbon backbone also carries first aliphatic moieties that have a main chain of about 3 to about 20 carbon atoms and 0 to about 3 heteroatoms. The heteroatoms are selected from the group N, O, S, Se and Si. The hydrocarbon backbone further carries second aliphatic moieties that have a copolymerisable group. The second aliphatic moieties have a main chain of about 3 to about 80 carbon atoms and about 2 to about 40 heteroatoms. The heteroatoms are selected from N and 0. Further, the process includes providing a maleic anhydride polymer of formula (I)

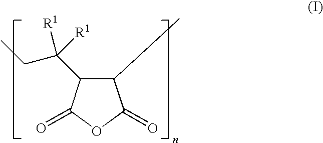

In formula (I) n is an integer from about 10 to about 10000. R¹ is H or methyl. The process also includes reacting in a suitable solvent the maleic anhydride polymer of formula (I) with a monofunctional compound and an at least bifunctional compound. The monofunctional compound has an alkyl chain of about 3 to about 20 carbon atoms and 0 to about 2 heteroatoms. The heteroatoms are selected from the group N, O, S, Se and Si. The functional group of the monofunctional compound is capable of forming a linkage with an anhydride. The at least bifunctional compound has an alkyl chain of about 3 to about 80 carbon atoms and 0 to about 40 heteroatoms. The heteroatoms are selected from N and 0. One functional group of the at least bifunctional compound is capable of forming a linkage with an anhydride. Another functional group of the at least bifunctional compound is copolymerisable. In the process only the functional group of the at least bifunctional compound capable of forming a linkage with an anhydride is allowed to react with the maleic anhydride polymer of formula (I).

According to a second aspect, the invention provides a process of forming an amphiphilic polymer. The amphiphilic polymer includes a hydrocarbon backbone. The hydrocarbon backbone of the amphiphilic polymer carries —COOH side groups. The hydrocarbon backbone also carries first aliphatic moieties that have a main chain of about 3 to about 20 carbon atoms and 0 to about 3 heteroatoms. The heteroatoms are selected from the group N, O, S, Se and Si. The hydrocarbon backbone further carries second aliphatic moieties that have a copolymerisable group. The second aliphatic moieties are defined by a poly(ethylene oxide) including chain. Further, the process includes providing a maleic anhydride polymer of formula (I) (supra). The process also includes reacting in a suitable solvent the maleic anhydride polymer of formula (I) with a monofunctional compound and a polyethyleneglycol or a diaminoalkyl-polyethyleneglycol. The monofunctional compound has an alkyl chain of about 3 to about 20 carbon atoms and 0 to about 2 heteroatoms. The heteroatoms are selected from the group N, O, S, Se and Si. The functional group of the monofunctional compound is capable of forming a linkage with an anhydride. The at least bifunctional compound has an alkyl chain of about 3 to about 80 carbon atoms and 0 to about 40 heteroatoms. The heteroatoms are selected from N and O. In the process only one terminal group of the polyethyleneglycol or the diaminoalkyl-polyethyleneglycol is allowed to react with the maleic anhydride polymer of formula (I).

According to a third aspect, the invention relates to an amphiphilic polymer of the general formula (II):

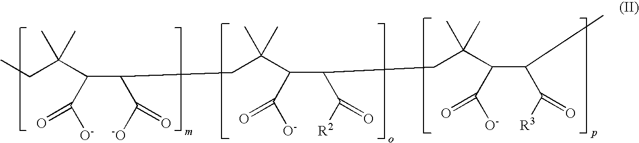

In formula (II) each of m, o and p is an independently selected integer from about 3 to about 400. The sum of m+o+p is selected in the range from about 10 to about 10000. R² is a first aliphatic moiety with a main chain of about of about 3 to about 20 carbon atoms and 0 to about 3 heteroatoms. The heteroatoms are selected from the group N, O, S, Se and Si. R³ is a second aliphatic moiety with a main chain of about 3 to about 80 carbon atoms and 0 to about 40 heteroatoms. The heteroatoms are selected from N and O. R³ has a copolymerisable group.

According to a fourth aspect, the invention provides a method of forming a water-soluble nanocrystal. The method includes providing a nanocrystal in a suitable solvent. The method also includes contacting the nanocrystal with an amphiphilic polymer according to the third aspect. The method also includes allowing non-covalent or covalent interaction between the amphiphilic polymer and the nanocrystal to occur. As a result a water-soluble nanocrystal is formed.

According to a fifth aspect, the invention provides a further method of forming a water-soluble nanocrystal. The method includes providing a nanocrystal in a suitable solvent. The method also includes contacting the nanocrystal with an amphiphilic polymer. The amphiphilic polymer includes a hydrocarbon backbone. The hydrocarbon backbone carries polar side groups. The hydrocarbon backbone also carries first aliphatic moieties. The first aliphatic moieties have a main chain of about 3 to about 20 carbon atoms and 0 to about 3 heteroatoms. The heteroatoms are selected from the group N, O, S, Se and Si. The hydrocarbon backbone also carries second aliphatic moieties. The second aliphatic moieties have a main chain of about 3 to about 80 carbon atoms and 0 to about 40 heteroatoms. The heteroatoms are selected from N and O. Further, the second aliphatic moieties have a copolymerisable group. The method also includes allowing non-covalent or covalent interaction between the amphiphilic polymer and the nanocrystal to occur. As a result a water-soluble nanocrystal is formed.

According to a sixth aspect, the invention provides a water-soluble nanocrystal. The water-soluble nanocrystal includes on its surface via non-covalent or covalent interaction an amphiphilic polymer according to the third aspect.

According to a seventh aspect, the invention provides a water-soluble nanocrystal. The water-soluble nanocrystal is obtainable by the method according to the fourth and/or the fifth aspect.

According to an eight aspect, the invention provides an amphiphilic polymer for the formation of a polymer meshwork. The amphiphilic polymer includes a hydrocarbon backbone. The hydrocarbon backbone carries polar side groups. The hydrocarbon backbone also carries side chains that have an alkyl chain of about 3 to about 80 carbon atoms and 0 to about 40 heteroatoms. The heteroatoms are selected from N and O. The side chains of the hydrocarbon backbone have a copolymerisable group.

According to a ninth aspect, the invention relates to the use of an amphiphilic polymer in the formation of a polymer meshwork. The amphiphilic polymer is an amphiphilic polymer according to the third aspect.

### BRIEF DESCRIPTION OF THE DRAWINGS

The invention will be better understood with reference to the detailed description when considered in conjunction with the non-limiting examples and the accompanying drawings.

FIG. 1 illustrates a method of forming water-soluble quantum dots according to the invention—from the suspension of QDs to submicrometer QDs/PNIPAM spheres. A: synthesis of TOP-terminated quantum dots. B: Quantum dots in water with amphiphilic functional polymer. C: Copolymerisation with monomer (e.g. NIPAM). D: Cross-polymerised quantum dots without addition of a monomer.

FIG. 2A illustrates the general scheme of the synthesis of the polymers according to the invention. FIGS. 2B-2D depict further examples of polymers that may be obtained using the general scheme of FIG. 2A. FIGS. 2E-2H depict further examples of reactants for forming the polymers according to the invention: FIG. 2E: trichloro[3-(2-propenyloxy)propyl]-silane (Chemical Abstracts No 79745-60-1); FIG. 2F: 1-nitro-2-(2-propenyloxy)-butane (CAS No 132439-78-2); FIG. 2G: 7-Iodo-1-heptene (CAS No 107175-49-5); FIG. 2H: N-(6-Bromohexyl)acrylamide (CAS No 869563-87-1).

FIG. 3A depicts a photo of TOPO-coated CdSe/ZnS quantum dots in chloroform (left) and of aqueous solutions of quantum dots coated with polymers 8 and 6 (see FIG. 2A).

FIG. 3B depicts absorption spectra of TOPO-coated CdSe/ZnS QDs in chloroform, and of aqueous solutions of QDs coated with polymers 8 and 6.

FIG. 3C depicts emission (λₑₓ=500nm) spectra of TOPO-coated CdSe/ZnS QDs in chloroform, and of aqueous solutions of QDs coated with polymers 8 and 6. Although the absorption spectrum in FIG. 3B shows minor changes, the emission spectra remain unaffected.

FIG. 4A depicts a transmission electron microscope (TEM) micrograph of polymer coated quantum dots. High resolution imaging reveals the size, and high crystallinity of a single quantum dot (inset).

FIG. 4B depicts a 500 nm×500 nm atomic force microscopy (AFM) height image (z-scale=10 nm) of polymer coated QDs on silicon surface deposited from water solution. The polymer/QD assemblies are spherically shaped and the polymer uniformly coats the quantum dot.

FIG. 5 shows TEM (A) and scanning electron microscope (SEM) (B) images of PNIPAM microgel with incorporated CdSe/ZnS QDs coated with the polymer depicted in FIG. 2B —(NHCH₂CH═CH₂).

FIG. 6 depicts TEM images of PNIPAM microgel particles with incorporated CdSe/ZnS QDs coated with the polymer depicted in FIG. 2D —(OCH₂CH₂OC(O)CH═CH₂).

FIG. 7 depicts SEM images of a PNIPAM microgel with incorporated CdSe/ZnS QDs coated with the polymer depicted in FIG. 2C —(NHCH₂CH₂NHC(O)CH═CH₂).

FIG. 8 depicts TEM (A) and SEM (B) images of self-polymerized CdSe/ZnS QDs coated with the polymer depicted in FIG. 2D —(OCH₂CH₂OC(O)CH═CH₂).

FIG. 9 depicts fixed (A) and live cells (B) mammalian cancer cells C-6 imaged with red quantum dots coated with polymer 2, nucleus stained blue with DAPI. Cells were incubated with QDs for 1 hr and then washed to remove excess of free nanocrystals.

FIG. 10 illustrates the behaviour of stimulus responsive QD microgels that include poly(N-isopropyl acrylamide) (PNIPAM).

FIG. 11 schematically illustrates the coating of QDs with vinyl-functionalized polymers.

FIG. 12 depicts an SEM image of stimulus responsive QD microgels that include poly(N-isopropyl acrylamide) (PNIPAM) below the lower critical solution temperature (LCST) of PNIPAM. Scale bar=2 μm.

FIG. 13 depicts an SEM image of stimulus responsive QD microgels that include PNIPAM above the lower critical solution temperature (LCST) of PNIPAM. Scale bar=2 μm.

FIG. 14 shows the narrow size distribution of stimulus responsive QD microgels that include PNIPAM.

FIG. 15 illustrates the reversibility of the volume phase transitions of stimulus responsive QD microgels that include PNIPAM in terms of its absorbance. Before (1, 4) and after 10 cycles between 20° C. and 60° C. (2, 3) the absorbtion curves of the microgels are indistinguishable.

FIG. 16 depicts an SEM image of PNIPAM/QDs microspheres synthesised by reversed emulsion polymerization.

FIG. 17 is a TEM image, depicting an edge of a large PNIPAM sphere (darker right part of the picture) with QDs embedded in the polymer matrix.

FIG. 18 is a fluorescent microscopy image, illustrating that the polymeric film preserves fluorescent properties.

FIG. 19A schematically recites the formation and the general structure of polymers used for coating of QDs. FIGS. 19B and 19C show exemplary effects and applicability of side chains R² of a corresponding polymer.

### DETAILED DESCRIPTION OF THE INVENTION

The invention relates inter alia to an amphiphilic polymer as well as to a process of the formation of such a polymer. It also relates to an amphiphilic particle coating. The term amphiphilic refers to a polymer that is soluble in both polar and non-polar fluids. It also encompasses multiphase polymers albeit a polymer according to the invention is typically used in only one phase and may be employed to solubilise matter in a desired phase, including to stabilize a phase interface and for phase-transfer purposes. The amphiphilic properties of the polymer are due to the presence of both polar and non-polar moieties within the same polymer. In this regard the polymer may be of surfactant nature. Accordingly, the polar properties of a polymer according to the invention are based on polar moieties. One such moiety are —COOH side groups, in particular in the form of charged COO⁻ groups, that the hydrocarbon backbone of the polymer carries. Generally, a surfactant molecule includes a polar, typically hydrophilic, headgroup attached to a non-polar, typically hydrocarbon, moiety. Non-polar moieties of the polymer include the hydrocarbon backbone as well as aliphatic moieties that the hydrocarbon backbone carries.

The term “aliphatic” means, unless otherwise stated, a straight or branched hydrocarbon chain, which may be saturated or mono- or poly-unsaturated and include heteroatoms (see below). An unsaturated aliphatic group contains one or more double and/or triple bonds (alkenyl or alkinyl moieties). The branches of the hydrocarbon chain may include linear chains as well as non-aromatic cyclic elements. The hydrocarbon chain, which may, unless otherwise stated, be of any length, and contain any number of branches. Typically, the hydrocarbon (main) chain includes 1 to 5, to 10, to 15 or to 20 carbon atoms. Examples of alkenyl radicals are straight-chain or branched hydrocarbon radicals which contain one or more double bonds. Alkenyl radicals generally contain about two to about twenty carbon atoms and one or more, for instance two, double bonds, such as about two to about ten carbon atoms, and one double bond. Alkynyl radicals normally contain about two to about twenty carbon atoms and one or more, for example two, triple bonds, preferably such as two to ten carbon atoms, and one triple bond. Examples of alkynyl radicals are straight-chain or branched hydrocarbon radicals which contain one or more triple bonds. Examples of alkyl groups are methyl, ethyl, propyl, butyl, pentyl, hexyl, heptyl, octyl, nonyl, decyl, the n isomers of these radicals, isopropyl, isobutyl, isopentyl, sec-butyl, tert-butyl, neopentyl, 3,3 dimethylbutyl. Both the main chain as well as the branches may furthermore contain heteroatoms as for instance N, O, S, Se or Si or carbon atoms may be replaced by these heteroatoms.

The term “alicyclic” means, unless otherwise stated, a non-aromatic cyclic moiety (e.g. hydrocarbon moiety), which may be saturated or mono- or poly-unsaturated. The cyclic hydrocarbon moiety may also include fused cyclic ring systems such as decalin and may also be substituted with non-aromatic cyclic as well as chain elements. The main chain of the cyclic hydrocarbon moiety may, unless otherwise stated, be of any length and contain any number of non-aromatic cyclic and chain elements. Typically, the hydrocarbon (main) chain includes 3, 4, 5, 6, 7 or 8 main chain atoms in one cycle. Examples of such moieties include, but are not limited to, cyclopentyl, cyclohexyl, cycloheptyl, or cyclooctyl. Both the cyclic hydrocarbon moiety and, if present, any cyclic and chain substituents may furthermore contain heteroatoms, as for instance N, O, S, Se or Si, or a carbon atom may be replaced by these heteroatoms. The term “alicyclic” also includes cycloalkenyl moieties which that are unsaturated cyclic hydrocarbons, which generally contain about three to about eight ring carbon atoms, for example five or six ring carbon atoms. Cycloalkenyl radicals typically have a double bond in the respective ring system. Cycloalkenyl radicals may in turn be substituted. Examples of such moieties include, but are not limited to, cyclohexenyl, cyclooctenyl or cyclodecenyl.

The term “aromatic” means, unless otherwise stated, a planar cyclic hydrocarbon moiety of conjugated double bonds, which may be a single ring or include multiple fused or covalently linked rings, for example, 2, 3 or 4 fused rings. The term aromatic also includes alkylaryl. Typically, the hydrocarbon (main) chain includes 5, 6, 7 or 8 main chain atoms in one cycle. Examples of such moieties include, but are not limited to, cylcopentadienyl, phenyl, naphthalenyl-, anthracenyl-, [10]annulenyl-(1,3,5,7,9-cyclodecapentaenyl-), [12]annulenyl-, [8]annulenyl-, phenalene (perinaphthene), 1,9-dihydropyrene, chrysene (1,2-benzophenanthrene). An example of an alkylaryl moiety is benzyl. The main chain of the cyclic hydrocarbon moiety may, unless otherwise stated, be of any length and contain any number of heteroatoms, as for instance N, O and S. Examples of such heteroaromatic moeities (which are known to the person skilled in the art) include, but are not limited to, furanyl-, thiophenyl-, naphtyl-, naphthofuranyl-, anthrathiophenyl-, pyridinyl-, pyrrolyl-, quinolinyl-, naphthaquinolinyl-, quinoxalinyl-, indolyl-, benzindolyl-, imidazolyl-, oxazolyl-, oxoninyl-, oxepinyl-, benzoxepinyl-, azepinyl-, thiepinyl-, selenepinyl-, thioninyl-, azecinyl-(azacyclodecapentaenyl-), diazecinyl-, azacyclododeca-1,3,5,7,9,11-hexaene-5,9-diyl-, azozinyl-, diazocinyl-, benzazocinyl-, azecinyl-, azaundecinyl-, thia[11]annulenyl-, oxacyclotrideca-2,4,6,8,10,12-hexaenyl- or triazaanthracenyl-moieties.

By the term “arylaliphatic” is meant a hydrocarbon moiety, in which one or more aromatic moieties are substituted with one or more aliphatic groups. Thus the term “arylaliphatic” also includes hydrocarbon moieties, in which two or more aryl groups are connected via one or more aliphatic chain or chains of any length, for instance a methylene group. Typically, the hydrocarbon (main) chain includes 5, 6, 7 or 8 main chain atoms in each ring of the aromatic moiety. Examples of arylaliphatic moieties such as alkylaryl moieties include, but are not limited, to 1-ethyl-naphthalene, 1,1′-methylenebis-benzene, 9-isopropylanthracene, 1,2,3-trimethyl-benzene, 4-phenyl-2-buten-1-ol, 7-chloro-3-(1-methylethyl)-quinoline, 3-heptyl-furan, 6-[2-(2,5-diethylphenyl)ethyl]-4-ethyl-quinazoline or, 7,8-dibutyl-5,6-diethyl-isoquinoline.

Each of the terms “aliphatic”, “alicyclic”, “aromatic” and “arylaliphatic” as used herein is meant to include both substituted and unsubstituted forms of the respective moiety. Substituents my be any functional group, as for example, but not limited to, amino, amido, azido, carbonyl, carboxyl, cyano, isocyano, dithiane, halogen, hydroxyl, nitro, organometal, organoboron, seleno, silyl, silano, sulfonyl, thio, thiocyano, trifluoromethyl sulfonyl, p-toluenesulfonyl, bromobenzenesulfonyl, nitrobenzenesulfonyl, and methane-sulfonyl.

The aliphatic moieties, which the hydrocarbon backbone carries, may carry further moieties such as side chains. Such further moieties may be an aliphatic, alicyclic, aromatic, arylaliphatic or arylalicyclic group that typically is of a main chain length of 1 to about 10, to about 15 or to about 20 carbon atoms. These further moieties may also carry functional groups (supra).

The hydrocarbon backbone carries first and second aliphatic moieties. The first aliphatic moieties have a main chain of about 3 to about 20 carbon atoms, including about 5 to about 20 carbon atoms, about 7 to about 20 carbon atoms, such as 3, 4, 5, 6, 7, 8, 9, 10, 11, 12, 13, 14, 15, 16, 17, 18, 19 or 20 carbon atoms or about 5 to about 15 carbon atoms. Further, the first aliphatic moieties have 0 to about 3 heteroatoms, including 1, 2 or 3 heteroatoms, such as N, O, S, Se or Si. An illustrative example of a suitable first aliphatic moiety is an alkyl moiety with a heteroatom, via which it is bonded to a carbonyl group carried by the aliphatic backbone of the polymer. Instead of a free carboxyl group the backbone thus carries an ester, a thio ester, a seleno ester or an amido group. In one embodiment the first aliphatic moiety is linked to the backbone via an amide bond which is formed by reacting the respective amine with the maleic anhydride polymer and is defined by an unbranched alkyl moiety, such as an n-octyl moiety.

The second aliphatic moieties have a main chain of about 3 to about 80 carbon atoms, including of about 3 to about 60 carbon atoms, of about 3 to about 40 carbon atoms, of about 10 to about 80 carbon atoms, of about 10 to about 60 carbon atoms, of about 25 to about 60 carbon atoms, of about 10 to about 40 carbon atoms, of about 3 to about 20 carbon atoms or about 3 to about 10 carbon atoms, such as 3, 4, 5, 6, 7, 8, 9, 10, 11, 12, 13, 14, 15, 16, 17, 18, 19, 20, 24, 25, 26, 27, 28, 29, 30, 31, 32, 33, 34, 35, 36, 37, 38, 39, 40, 41, 42, 43 or 44 carbon atoms. Further, the second aliphatic moieties have 0 to about 44 heteroatoms, including 0 to about 40 heteroatoms, 1 to about 40 heteroatoms, about 2 to about 40 heteroatoms, about 2 to about 30 heteroatoms or about 0 to about 3 heteroatoms such as 1, 2, 3, 4, 5, 6, 7, 8, 9, 10, 11, 12, 13, 14, 15, 16, 17, 18, 19, 20, 21, 22, 25, 26, 27, 28, 29, 30, 31, 32, 33, 34, 35, 36, 37, 38, 39, 40, 41, 42, 43 or 44 heteroatoms, such as N or O. The second aliphatic moieties further have a copolymerisable group. The copolymerisable group may also be called cross-polymerisable in order to emphasize that both intra- and intermolecular copolymerization can occur. This copolymerisable group is typically also cross-linkable. The copolymerizable group can be any group that bears functionality of monomer, i.e. any such desired group that can be polymerized.

The usability of each group may depend on several conditions, for example the respective application, the reaction conditions, the wanted degree of water-solubility of the resulting polymer, etc and can be determined empirically, if wanted. Examples of a suitable copolymerisable group include, but are not limited to, an amino group, a hydroxyl group, an epoxide group, an oxetane group, a C═C group (either an internal C═C group and/or a terminal C═C group) such as an allyl group as well as an allyl glycidyl ether group, a C≡C group (either an internal C≡C group and/or a terminal C≡C group), a coupled —C═C—C═C— group (either an internal coupled —C═C—C═C— group and/or a terminal coupled —C═C—C═C— group) or substituted derivatives thereof. The copolymerisable group may thus be bonded to any position of the second aliphatic moieties and can be an internal group and/or a terminal group. In some embodiments it is a terminal functional group, for example a terminal C═C group. As an illustrative example, the terminal C═C group may be a vinyl group such as —CH═CH₂. Examples of an internal C═C group further include, but are not limited to, an allyl group such as —CH═CH—CH₃ or an acryl group such as —CH═CH—C(O). The term “internal” thus refers to a copolymerisable group in which the terminal main chain atom is not part of the copolymerisable reaction center. Non limiting examples of suitable C═C groups, both internal and terminal, may be acrylic and methacrylic amides, acrylic and methacrylic esters, vinyl or acetylene moieties or a butadiene moiety.

In one embodiment of the present invention, the second aliphatic moieties may be defined by a poly(ethylene oxide) including chain. The poly(ethylene oxide) including chain may for example include a polyethyleneglycol (PEG) or a diaminoalkyl-polyethyleneglycol moiety, wherein only one terminal group of the polyethyleneglycol or the diaminoalkyl-polyethyleneglycol is allowed to react with the maleic anhydride polymer of formula (I). PEG is commercially available over a wide range of molecular weights. The lower limit of molecular weight of the polymer may be higher than 100, depending on the size and number of groups present in each repeating unit. If the polymer is derived from a low molecular weight repeating unit (e.g. having small side chains) such as a polyol or a polyamine, then the lower limit of the molecular weight of the polymer can be low. In the case of a polymer in which the repeating units have a high molecular weight (e.g. bearing bulky side chains), then the lower limit may be higher than 100. In some embodiments, the lower limit of molecular weight of a polymer may be about 400, about 500, about 600, about 1000, about 1200, about 1500, or higher at about 2000. For example, the PEG may have a molecular weight of more than about 500, more than about 1000, more than about 5000, more than about 10000 or even more than about 25.000 daltons. The molecular weight can for example be chosen in such a way, that an efficient wrapping of the amphiphilic polymer around nanocrystals is or can be ensured, as explained in more detail below. PEG is known to increase the colloidal stability of nanoparticles. Further, PEGylated surfaces offer reduced nonspecific interaction with biological molecules and cells. The more PEG that is attached to the polymer shell, the bigger the size of the resulting particles. Illustrative examples of a suitable polyethyleneglycol moiety are a (methoxypoly(ethylene glycol)), abbreviated mPEG, or PEG 600 moiety. Numerous PEG are available having different geometries. An illustrative example of a suitable diaminoalkyl-polyethyleneglycol moiety is a diaminopropyl PEG moiety. The diaminoalkyl-polyethylene-glycol moiety may for instance be PEG(NH₂)₂ 1500 or a PEG (having one or two amino groups) with an molecular weight of about 5000 to 6000. In the meantime the ease of the formation of such polymers has been confirmed by the synthesis of a polymer in which the first aliphatic moiety is a dodecylamino moiety.

In a further embodiment of the present invention, the second aliphatic moieties may be be chosen from further polymers that may be water soluble. For example, polymers having a terminated nucleophilic function may be used. Examples of such polymers are, but are not limited to, polypropylene glycol, polyacrylic acid, polystyrene sulfate, polylactic acid or polyvinyl alcohol. Further polymers known to the skilled man in the art having comparable properties may also be used in the present invention.

The amphiphilic polymer may in some embodiments be of the general formula (II):

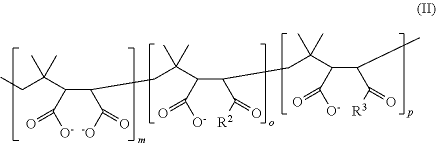

In formula (II) each of m, o and p is an independently selected integer from 0 to about 400, including from 1 to about 400 or about 2 to about 400, such as about 0 to about 400, about 0 to about 350, about 0 to about 300, about 3 to about 300, about 0 to about 250, about 0 to about 200, about 2 to about 200, about 0 to about 150, about 2 to about 150, about 0 to about 200, about 1 to about 200, about 3 to about 100, about 2 to about 100, about 0 to about 100, about 3 to about 50, about 2 to about 50, about 1 to about 50 or about 0 to about 50. As further illustrations, m may in some embodiments be selected in the range from about 5 to about 50, such as about 10 to about 45 including about 10 to about 43, whereas p may for instance be selected in the range from about 3 to about 40, such as about 3 to about 35 or about 4 to about 30, and p may for example be selected in the range from 0 to about 30, such as from 0 to about 25 or from 0 to about 20. The sum of m +o +p is selected in the range from about 10 to about 10000, including about 10 to about 8000, about 10 to about 6000, about 10 to about 5000, about 10 to about 4000, about 10 to about 2000, about 10 to about 1000, about 10 to about 750, about 10 to about 600, about 10 to about 400, about 10 to about 250, about 10 to about 150, about 10 to about 100, about 15 to about 150, about 20 to about 150, about 15 to about 100, or about 20 to about 100. In some embodiments each of m, o and p is an independently selected integer from about 2 to about 300, including from about 3 to about 300, about 3 to about 250, about 3 to about 200, about 3 to about 150 or about 2 to about 200, about 3 to about 100, about 2 to about 100, about 3 to about 80, about 2 to about 80, about 3 to about 40 or about 2 to about 40 and the sum of (m +o +p) is selected in the range from about 6 to about 400, including from about 10 to about 400, from about 10 to about 350, from about 10 to about 300, from about 10 to about 250, from about 10 to about 200, from about 6 to about 200, from about 10 to about 150, from about 6 to about 150, from about 10 to about 100, from about 6 to about 100, from about 10 to about 50 or from about 6 to about 50. In one embodiment the sum of (m+o+p) is 32. In another embodiment the sum of (m+o+p) is 48. The ratio of p/(m+o) may be selected in the range from 0 to about 25, such as from 0 to about 20, from 0 to about 15, from 0 to about 12, from 0 to about 10, from 0 to about 8, from about 0 to about 6, to about 4, to about 3 or to about 2. In one embodiment the ratio of p/(m+o) is about 1.

R² is the first aliphatic moiety described above, with a main chain of about 3 to about 20 carbon atoms and 0 to about 3 heteroatoms. The heteroatoms are selected from the group N, O, S, Se and Si. R³ is the second aliphatic moiety described above, with a main chain of about 3 to about 80 carbon atoms and 0 to about 40 heteroatoms. The heteroatoms are selected from N and O. The second aliphatic moiety R³ has a copolymerisable group. It is understood that the individual units indicated in formula (II) may be arranged in any, including random, order—rather than in the form of blocks. Thus, general formula (II) merely defines that m units of:

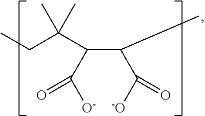

o units of:

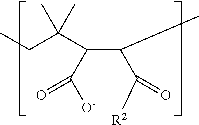

and p units of:

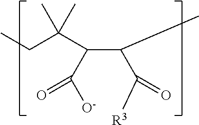

are present in the polymer. A polymer according to the invention may therefore encompass any sequence of these units. As an illustrative example a respective sequence may include the following arrangement of units:

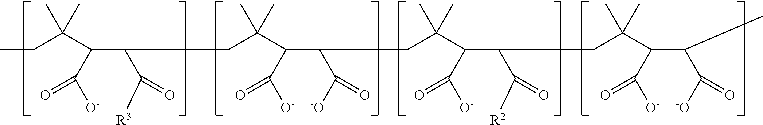

An amphiphilic polymer according to the invention may be prepared by the process described herein. The amphiphilic polymer is typically at least essentially free of cross-links. Accordingly, in the amphiphilic polymer the copolymerisable group (supra) of the second aliphatic moiety R³ is available for any crosslinking or copolymerization reaction.

In the process of forming an amphiphilic polymer according to the invention a maleic anhydride polymer of formula (I) (supra) is used as a reactant, which forms the hydrophilic backbone on the amphiphilic polymer. The maleic anhydride polymer may be the commercially available poly(isobutylene-alt-maleic anhydride) of Chemical Abstracts No. 26426-80-2, also termed isobutylene-maleic acid anhydride copolymer. It is inter alia available under the names BM 30AE20, Fibersorb™ SA 7200H, IB 6, KI Gel and Isobam®. It is also available from e.g. Sigma-Aldrich (St. Louis, Mo., USA) or SinoChemexper Company (Shanghai, PRC). The maleic anhydride polymer may also be poly(ethylene-alt-maleic anhydride) of Chemical Abstracts No. 106973-21-1, also termed ethylene-maleic anhydride alternating copolymer. It is for example available from Rutherford Chemicals (Bayonne, N.J.) under product code 27109P, as well as under the names ZeMac® E 400 or ZeMac® E 60. In formula (I) above n may be any integer from about 10 to about 10000, such as about 10 to about 5000, about 10 to about 2000, about 10 to about 1000, about 20 to about 1000, about 10 to about 800, about 20 to about 800, such as about 10 to about 400. In one embodiment n is 32. The above examples of maleic anhydride polymers are not to be considered as being limiting but every available maleic anhydride polymer (and also those yet to be synthesized), in particular a maleic anhydride polymer which may be prepared according to standard procedures as described are suitable to be used in the present invention. Respective maleic anhydride polymers may for instance be formed following the procedures described in U.S. Pat. Nos. 3,846,383 and 6,316,554. A general standard procedure used in the art is also summarized in the abstract of Frank, H. P., Makromolekulare Chemie (1968) 114, 113-121 and involves the free-radical copolymerisation. of maleic anhydride with an olefin in the presence of e.g. a peroxide.

As further reactants a monofunctional compound and an at least bifunctional compound are used. In the course of the process the monofunctional compound is converted to the first aliphatic moiety R² described above. The functional group of the monofunctional compound is capable of forming a linkage with an anhydride. The at least bifunctional compound is converted into the second aliphatic moiety R³ (supra). The at least bifunctional compound may have two, three, four or more functional groups. One of the functional groups is capable of forming a linkage with an anhydride. Another of the functional groups of the at least bifunctional compound is copolymerisable. The reaction of a fraction of the anhydride rings with the monofunctional compounds leads to the formation of the hydrophobic side chains that can interact with the hydrophobic surface of nanoparticles as described herein. Another fraction of the anhydride rings is used to link the at least bifunctional compounds to the backbone. Control over the number of hydrophobic units with respect to the number of carboxyl groups in the backbone of polymers may be achieved by changing the amount of nucleophilic reactants used for the reaction with the polyanhydride chain. Thus, the monofunctional compound of the invention may react with at least about 25% of the available anhydride rings, such as at least about 35%, at least about 50%, at least about 70% or at least about 75%. The at least bifunctional compound of the invention may react with at least about 5% of the available anhydride rings, such as at least about 8%, at least about 10%, at least about 15%, at least about 20% or at least about 25%.

The functional group of the monofunctional compound may be selected from, but is not limited to, an amino group, a hydroxyl group, a thiol group, a selenol group, a halogen group, an ether group, a thioether group or the like. The monofunctional compound has an alkyl chain of about 2 to about 20 carbon atoms, such as about 3 to about 20 carbon atoms, including about 5 to about 20 carbon atoms, about 5 to about 15 carbon atoms, about 7 to about 20 carbon atoms, such as 2, 3, 4, 5, 6, 7, 8, 9, 10, 11, 12, 13, 14, 15, 16, 17, 18, 19 or 20 carbon atoms. Further, the monofunctional compound has 0 to about 2 heteroatoms, such as one heteroatom. The heteroatoms may for instance be N, O, S, Se or Si. Examples of monofunctional compounds may be, but are not limited to, alkylamines, wherein the alkyl group is as defined above. In one embodiment the alkylamin may be n-propylamine, n-butyl-amine, n-pentylamine, n-hexylamine, n-octylamine or n-dodecylamine.

Generally, the at least bifunctional group has two or more different functional groups. Any functional group may be selected for each of the at least two functionalities as long as one, typically merely one, of them is capable of forming a linkage with an anhydride. One group, which reacts with the maleic anhydride moiety may be selected from, but is not limited to, an amino group, a hydroxyl group, a thiol group, a selenol group, a halogen group, an ether group, a thioether group or the like. The second functional group, which does not react with the maleic anhydride moiety, may be a copolymerisable group. Copolymerizable means that this group may be polymerized with another functional group. Examples of a suitable copolymerisable group include, but are not limited to, an amino group, a hydroxyl group, an allyl glycidyl ether group, an epoxide group, an oxetane group, and a C═C bond such as an allyl group.

The at least bifunctional compound has an alkyl chain of about 3 to about 80 carbon atoms, including of about 3 to about 70 carbon atoms, about 3 to about 60 carbon atoms, of about 3 to about 40 carbon atoms, of about 10 to about 80 carbon atoms, of about 10 to about 60 carbon atoms, of about 25 to about 60 carbon atoms, of about 10 to about 40 carbon atoms, of about 3 to about 20 carbon atoms or about 3 to about 10 carbon atoms, such as 3, 4, 5, 6, 7, 8, 9, 10, 11, 12, 13, 14, 15, 16, 17, 18, 19, 20, 24, 25, 26, 27, 28, 29, 30, 31, 32, 33, 34, 35, 36, 37, 38, 39, 40, 41, 42, 43 or 44 carbon atoms. Further, the at least bifunctional compound has 0 to about 45 heteroatoms, including 0 to about 40 heteroatoms, 1 to about 40 heteroatoms, about 2 to about 40 heteroatoms, about 2 to about 30 heteroatoms or about 0 to about 3 heteroatoms such as 1, 2, 3, 4, 5, 6, 7, 8, 9, 10, 11, 12, 13, 14, 15, 16, 17, 18, 19, 20, 21, 22, 25, 26, 27, 28, 29, 30, 31, 32, 33, 34, 35, 36, 37, 38, 39, 40, 41, 42 or 43 heteroatoms, such as N or O.

Examples of a suitable bifunctional compound with a terminal group —CH═CH₂ include, but are not limited to, 1-amino-4-pentene (Chemical Abstracts No. 22537-07-1), 8-nonen-1-amine (CAS No. 151626-27-6), 9-decen-1-amine (CAS No. 51382-01-5), 1-nonen-4-amine (CAS No. 66838-76-4), 10-undecen-1-amine (the hydrochloride has CAS No. 682814-20-6), (R)-1-decen-5-amine (CAS No. 117960-06-2), 1-octen-3-amine (CAS No. 119703-87-6), 1-decen-4-amine (CAS No 742081-49-8), 1-undecen-4-amine (CAS No 83948-41-8), (4R)-1-undecen-4-amine (CAS No. 910545-68-5), (4R)-4-ethyl-5-hexen1-amine (CAS No. 1005414-64-1), 2-methyl-1-nonen-4-amine (CAS No. 66838-77-5), 1,7-octadien-3-amine (CAS No. 71663-71-3), 1,7-octadien-4-amine (CAS No. 245450-11-7), (E)-7-nonen-4-amine (CAS No. 55713-48-9), 2-ethenyl-1,6-hexanediamine (CAS No. 184955-93-9), 6-heptene1-thiol (CAS No. 173777-16-7), 8-nonene-1-thiol (CAS No. 304435-87-8), 7-octene-1-thiol (the sodium salt has CAS No. 100845-39-4), 10-undecene-1-thiol (CAS No. 178561-30-3), 1-nonene-4-thiol (CAS No. 1006684-28-1), 5-hexene1-thiol (CAS No. 17651-39-7), 1,8-nonadiene-5-thiol (CAS No. 245450-18-4), 1,7-octadiene-4-thiol (CAS No. 245450-17-3), 13-tetradecene-1-thiol (CAS No. 1005387-18-7), trichloro[3-(2-propenyloxy)propyl]-silane, (CAS No. 79745-60-1), 2-methyl-2-propenoic acid 5-(trichlorosilyl)pentyl ester (CAS No. 374534-78-8), 7-bromo-1-heptene (CAS No. 4117-09-3), 6-bromo1-hexene (CAS No. 2695-47-8), 8-bromo1-octene (CAS No. 2695-48-9), 9-bromo-1-nonene (CAS No. 89359-54-6), 7-iodo-1-heptene (CAS No. 107175-49-5), 6-iodo1-hexene (CAS No. 18922-04-8), 8-iodo-1-octene (CAS No. 38380-55-1), 9-iodo-1-nonene (CAS No. 213207-73-9), 6-iodo-3-methyl1-hexene (CAS No. 106815-04-7), N-(6-aminohexyl)acrylamide (CAS No. 7530-30-5), N-(7-aminoheptyl)-2-propenamide (the hydrochloride has CAS No. 219613-81-7), N-(6-bromohexyl)acrylamide (CAS No. 869563-87-1), N-(6-bromohexyl)-2-methyl-2-propenamide (CAS No. 102303-85-5) and 1-nitro-2-(2-propenyloxy)-butane (CAS No. 132439-78-2). Further examples of bifunctional compounds may be, but are not limited to, a vinylic amine, a hydroxy alkyl acrylic ester or an amino alkyl acrylic amide. Suitable examples of vinylic amines may be, but are not limited to, 2-propen-1-amine or aminopropyl vinyl ether.

Examples of a suitable bifunctional compound with a terminal group —C≡CH include, but are not limited to, 7-octynylamine (CAS No. 14502-43-3), 1-heptyn-4-amine (CAS No. 138851-79-3), 10-undecyn1-amine (CAS No. 188584-11-4), 1-nonyn-5-amine (CAS No. 188585-70-8), 8-nonyn-2-amine (the (2R) isomer has CAS No. 481075-18-7), 8-bromo-1-octyne (CAS No. 81216-13-9), 6-bromo-3-methyl1-hexyne (CAS No. 255824-64-7), 7-chloro-1-heptyne (CAS No. 18804-36-9), 7-iodo-1-heptyne (CAS No. 87462-66-6), 7-octyne-1-thiol (CAS No. 77213-91-3), (CAS No. 70110-19-9) Three illustrative examples of a trifunctional compound with a terminal group —C≡CH are 6-heptyne-1,5-diamine (CAS No. 70110-19-9), 1,7-octadiyne-4-thiol (CAS No. 864226-49-3) and 1,7-octadiyne-4-thiol (CAS No. 864226-49-3).

Examples of a suitable bifunctional compound with an internal group —C≡C— include, but are not limited to, 5-heptyn-1-amine (CAS No. 255381-72-7), 4-heptyn-1-amine (CAS No. 184153-57-9), 1-amino-3-hexyne (CAS No. 582307-90-2), 1-methyl-2-hexynylamine (CAS No. 98435-28-0), 2-heptyn-1-amine (CAS No. 98435-26-8), 5-octyn-1-amine (CAS No. 135469-74-8), 3-nonyn-1-amine (CAS No. 86001-04-9), 3-ethyl-4-heptyn-3-amine (CAS No. 61822-34-2), 2-undecyne-1-thiol (CAS No. 865306-46-3), 6-octyne-1-thiol (CAS No. 77213-95-7), 1-hexyne-1-thiol (CAS No. 770676-32-9) and 1-(methylthio)-2-nonyne (CAS No. 113794-33-5). Two illustrative examples of a trifunctional compound with an internal group —C≡C— are 4-octyne-1,7-diamine (CAS No. 207980-95-8) and 4-nonyne-1,7-diamine (CAS No. 207980-97-0).

In the process of forming an amphiphilic polymer according to the invention the reaction between the maleic anhydride polymers of formula (I) (supra), the monofunctional compound and the at least bifunctional compound may be carried out in the presence of a base. Generally, any base suitable for the intended purpose may be used. In one embodiment the base is a nucleophilic base. A nucleophilic base is a base having basic properties as well as nucleophilic properties. Illustrative examples include, but are not limited to, lithium diisopropylamide, lithium tetramethylpiperidide, diisopropylethyl amine (Hünig's base), 1,5-diazabicyclo[4.3.0]-non-5-ene, 1,8-diazabicyclo[5.4.0]undec-7-ene, a bis(trimethylsilyl)amide, a hexamethyldisilazane or bismesitylmagnesium.

During the process of forming an amphiphilic polymer, typically a reaction of anhydride groups of the maleic anhydride polymer results in the formation of an amide or an ester group thereby providing a non-polar side chain. This side chain includes the moiety formed from the monofunctional compound, e.g. an alkyl chain, as well as at least one heteroatom, which is the respective atom of the ester or amido group to which the moiety formed from the monofunctional compound is bonded. The first aliphatic moiety thus includes the moiety formed from the monofunctional compound as well as the group COO—, CO—NH— or CO—N—. In embodiments where the group is CO—N— a secondary amide is formed and the first aliphatic moiety accordingly includes 2 moieties formed from the monofunctional compound.

It is noted in this regard that in embodiments where a secondary amide is formed the first aliphatic moiety may also include one moiety formed from the monofunctional compound and one moiety formed from the at least bifunctional compound. For the sake of clarity any aliphatic moiety that includes a moiety formed from the at least bifunctional compound shall be considered a second aliphatic moiety. Accordingly an aliphatic moiety that includes both a moiety formed from the monofunctional compound and a moiety formed from the at least bifunctional compound shall be considered a branched second aliphatic moiety.

Further, each anhydride group of the maleic anhydride polymer may react with one or two monofunctional compounds or with one or two at least bifunctional compounds (see also below). Typically an anhydride group undergoes a reaction with maximally one reactant, whether mono- or at least bifunctional compound. As a result a carboxylic acid group is formed, which typically provides a negative charge in solution. Additionally, a number of anhydride groups do not undergo a reaction. These anhydride groups are generally being hydrolysed in the course of the process of the invention, thereby providing further carboxylic acid groups. Those skilled in the art will appreciate that the process of the invention of forming an amphiphilic polymer does not require the use of any coupling agents such as cross-linkers.

While it has been previously shown that poly(isobutylene-alt-maleic anhydride) is capable of undergoing a reaction with an aliphatic amine (abstract of Japanese patent application JP 57016004, Fernandez-Arguelles, M. T., et al., Nano Letters (2008) 7, 9, 2613-2617), the present inventors made the surprising finding that furthermore bi-, tri- and higher functionalized compounds can be used as additional reactants in a one-pot synthesis. It is generally possible to control the reaction conditions in such a manner that the bi- or higher functionalized compound is allowed to undergo only one reaction, thereby forming only one link to the hydrocarbon backbone of the polymer. Remaining functional groups of the bi- or higher functionalized compound are subsequently available for coupling and cross-linking reactions. In this respect it should be noted that the hydrocarbon backbone of the amphiphilic polymer may carry polar side groups and side chains having an alkyl chain of about 3 to about 80 carbon atoms and 0 to about 40 heteroatoms selected from N and O, the side chains having a copolymerisable group. As stated above, the copolymerisable group may be an amino group, a hydroxyl group or a group containing a terminal or internal C═C or C≡C bond, such as a terminal group —CH═CH₂, a terminal group —C≡CH, an internal —CH≡CH— or an internal group —C≡C—. As indicated above, the copolymerisable group may also include a terminal or internal C═C or C≡C bond as well as an additional functional group or a vicinal or geminal heteroatom, for instance of the general structure -G-CH═CH— or G-C≡C— with G being N, O, or a group —CH═CH— or —C≡C—, for example.

The copolymerisable group may be the same or different from remaining groups of the at least bifunctional compound. In embodiments where the functional groups are the same, those functional groups that are not allowed to react with the maleic acid anhydride polymer may be shielded from participating in a polymerisation process. A large number of protecting groups, which are well known to those skilled in the art, is available for various functional groups. As an illustrative example, hydroxyl groups may be protected by an isopropylidene group. Such a protecting group may be removed after polymerisation and thus the functional group(s) that is/are no longer shielded are available for a coupling-, crosslinking or copolymerisation reaction. For example, the isopropylidene protecting group shielding a hydroxyl group may be removed by acid treatment. Those skilled in the art will furthermore be aware that such protecting groups may have to be introduced well in advance during the synthesis of the respective at least bifunctional compound.

In one embodiment the copolymerisable group is a head group of the side chain, wherein any other position on the side chain is also possible as long as a subsequent copolymerisation or cross linking reaction may be possible. It is possible to form a meshwork by this cross-linking reaction, as will be explained in more detail below.

In another embodiment the present invention provides a method of forming a water-soluble nanocrystal. Accordingly, a water soluble photoluminescent composite material that includes one or more nanocrystals and one or more polymers as described above can be formed using a method provided herein. This composite material may include only one or two or more different nanocrystals and/or polymers. With the inventive method the hydrophobic properties of nanocrystals may be converted to hydrophilic properties. Moreover, a versatile platform for solubilization and multifunctionalization of non-polar, typically hydrophobic (e.g. alkyl chain) terminated nanoparticles is therefore provided by changing their surface character and by introducing functionality. Thus, a coating on nanocrystals is provided that simultaneously solves problems related to solubility, multifunctionality, robustness and chemical versatility.

The term nanocrystal as used in the present invention may be considered as any nanomaterial with at least one dimension of for example <about 100 nm and that is single-crystalline. These materials are of huge technological interest since many of their electrical and thermodynamic properties show strong size dependence and can therefore be controlled through careful manufacturing processes. Semiconductor nanocrystals in the sub-10 nm size range are often referred to as quantum dots.

In accordance with the invention, any suitable type of nanocrystal (e.g. quantum dot) can be rendered water soluble, so as long as the surface of the nanocrystal can interact, for example, via hydrophobic interactions or van-der Waals interactions, with an amphiphilic polymer as described herein. In this context, the terms “nanocrystal” and “quantum dot” may be used interchangeably.

In one embodiment, suitable nanocrystals have a nanocrystal core that includes a metal (M1) alone. For this purpose, M1 may be selected from the group consisting of an element of main group II, subgroup VIIA, subgroup VIIIA, subgroup IB, subgroup IIB, main group III or main group IV of the periodic system of the elements (PSE). Accordingly, the nanocrystal core may consist of only the metal element M1; the non-metal element A or B, as defined below, is absent. In this embodiment, the nanocrystal consists only of a pure metal from any of the above groups of the PSE, such as gold, silver, copper (subgroup Ib), titanium (subgroup IVb), terbium (subgroup IIIb), cobalt, platinum, rhodium, ruthenium (subgroup VIIIb), lead (main group IV) or an alloy thereof.

In another embodiment, the nanocrystal core used in the present invention may include two elements. Accordingly, the nanocrystal core may be a binary nanocrystal alloy that includes two metal elements, M1 and M2, such as any well-known core-shell nanocrystal formed from metals such as Zn, Cd, Hg, Mg, Mn, Ga, In, Al, Fe, Co, Ni, Cu, Ag, Au and Au.

Another type of binary nanocrystals suitable in the present invention may include one metal element M1, and at least one element A selected from main group V or main group VI of the PSE. Accordingly, the one type of nanocrystal suitable for use presently has the formula M1A. Examples of such nanocrystals may be group II-VI semiconductor nanocrystals (i.e. nanocrystals including a metal from main group II or subgroup IIB, and an element from main group VI) wherein the core and/or the shell includes CdS, CdSe, CdTe, MgTe, ZnS, ZnSe, ZnTe, HgS, HgSe, or HgTe. The nanocrystal core may also be any group III-V semiconductor nanocrystal (i.e. nanocrystals including a metal from main group III and an element from main group V). The core and/or the shell includes GaN, GaP, GaAs, GaSb, InN, InP, InAs, InSb, AlN, AlP, AlAs, AlSb. Specific examples of core shell nanocrystals that can be used in the present invention include, but are not limited to, (CdSe)-nanocrystals having a ZnS shell, as well as (CdS)-nanocrystals having ZnS shell.

The invention is not limited to the use of the above-described core-shell nanocrystals. In another embodiment, the nanocrystal of the invention can have a core consisting of a homogeneous ternary alloy having the composition M1₁₋ₓM2ₓA, wherein
a) M1 and M2 are independently selected from an element of subgroup IIb, subgroup VIIa, subgroup VIIIa, subgroup Ib or main group II of the periodic system of the elements (PSE), when A represents an element of the main group VI of the PSE, or
b) M1 and M2 are both selected from an element of the main group (III) of the PSE, when A represents an element of the main group (V) of the PSE.

In another embodiment nanocrystals consisting of a homogeneous quaternary alloy can be used. Quaternary alloys of this type have the composition M1₁₋ₓM2ₓA_{y}B_{1-y}, wherein
a) M1 and M2 are independently selected from an element of subgroup IIb, subgroup VIIa, subgroup VIIIa, subgroup Ib or main group II of the periodic system of the elements (PSE), when A and B both represent an element of the main group VI of the PSE, or
b) M1 and M2 are independently selected from an element of the main group (III) of the PSE, when A and B both represent an element of the main group (V) of the PSE.

Examples of this type of homogenous ternary or quaternary nanocrystals have been described, for instance, in Zhong et al, J. Am. Chem. Soc (2003) 125, 8598-8594, Zhong et al, J. Am. Chem. Soc (2003) 125, 13559-13553, or the International patent application WO 2004/054923.

Such ternary nanocrystals are obtainable by a process that includes forming a binary nanocrystal M1A by
i) heating a reaction mixture containing the element M1 in a form suitable for the generation of a nanocrystal to a suitable temperature T1, adding at this temperature the element A in a form suitable for the generation of a nanocrystal, heating the reaction mixture for a sufficient period of time at a temperature suitable for forming said binary nanocrystal M1A and then allowing the reaction mixture to cool, and
ii) reheating the reaction mixture, without precipitating or isolating the formed binary nanocrystal M1A, to a suitable temperature T2, adding to the reaction mixture at this temperature a sufficient quantity of the element M2 in a form suitable for the generation of a nanocrystal, then heating the reaction mixture for a sufficient period of time at a temperature suitable for forming said ternary nanocrystal M1₁₋ₓM2ₓA and then allowing the reaction mixture to cool to room temperature, and isolating the ternary nanocrystal M1₁₋ₓM2ₓA.

In these ternary nanocrystals, the index x may have a value of 0.001<x<0.999, for example of 0.01<x<0.99, 0.1<0.9 or of 0.5<x<0.95. In other embodiments, x can have a value between about 0.2 or about 0.3 to about 0.8 or about 0.9. In quaternary nanocrystals, y may have a value of 0.001<y<0.999, for example of 0.01<y<0.99, or of 0.1<x<0.95 or between about 0.2 and about 0.8.

In such II-VI ternary nanocrystals, the elements M1 and M2 included therein may be independently selected from the group consisting of Zn, Cd and Hg. The element A of the group VI of the PSE in these ternary alloys is preferably selected from the group consisting of S, Se and Te. Thus, all combinations of these elements M1, M2 and A are within the scope of the invention. In illustrative embodiments nanocrystals used in the present invention have the composition ZnₓCd₁₋ₓSe, ZnₓCd₁₋ₓS, ZnₓCd₁₋ₓ, Te, HgₓCd₁₋ₓSe, HgₓCd₁₋ₓTe, HgₓCd₁₋ₓS, ZnₓHg₁₋ₓSe, ZnₓHg₁₋ₓTe, and ZnₓHg₁₋ₓS.

In some illustrative embodiments, x as used in the above chemical formulas has a value of 0.10<x<0.90 or 0.15<x<0.85, and more preferably a value of 0.2<x<0.8. In particularly preferred embodiments, the nanocrystals have the composition ZnₓCd₁₋ₓS and ZnₓCd₁₋ₓSe. Such nanocrystals are preferred in which x has a value of 0.10<x<0.95, and more preferably a value of 0.2<x<0.8.

In certain embodiments in which the nanocrystal core is made from III-V nanocrystals of the invention, each of the elements M1 and M2 are independently selected from Ga and In. The element A may be selected from P, As and Sb. All possible combinations of these elements M1, M2 and A are within the scope of the invention. In some illustrative embodiments, nanocrystals have the composition GaₓIn₁₋ₓP, Ga₁₋ₓIn₁₋ₓAs and GaₓIn₁₋ₓAs.

In one embodiment the nanocrystal includes semiconducting material. As explained above the semiconducting material may include a metal, a metalloid or both.

In the above method of the present invention first the nanocrystal is provided in a suitable solvent or mixtures of such solvents. Suitable in this respect means that the nanocrystal should be soluble in the respective solvent. Examples of such solvents are, but not limited to, aprotic solvents and/or non-polar solvents, such as an aprotic non-polar solvent. The latter may be selected from a mineral oil, hexane, heptane, cyclohexane, benzene, toluene, pyridine, dichloromethane, chloroform, carbon tetrachloride, carbon disulfide, dioxane, diethyl ether, diisopropylether, ethylene glycol monobutyl ether and tetrahydrofuran.

A further example of a suitable non-polar solvent is a non-polar ionic liquid. Examples of a non-polar ionic liquid include, but are not limited to, 1-ethyl-3-methylimidazolium bis[(trifluoromethyl)sulfonyl]amide bis(triflyl)amide, 1-ethyl-3-methylimidazolium bis-[(trifluoromethyl)sulfonyl]amide trifluoroacetate, 1-butyl-3-methylimidazolium hexafluorophosphate, 1-hexyl-3-methylimidazolium bis(trifluoromethylsulfonyl)imide, 1-butyl-3-methyl-imidazolium bis(trifluoromethylsulfonyl)imide, trihexyl(tetradecyl)phosphonium bis[oxalato (2-)]borate, 1-hexyl-3-methyl imidazolium tris(pentafluoroethyl)trifluorophosphate, 1-butyl-3-methyl-imidazolium hexafluorophosphate, tris(pentafluoroethyl)trifluorophosphate, trihexyl(tetradecyl)phosphonium, N″-ethyl-N,N,N′,N′-tertramethylguanidinium, 1-butyl-1-methyl pyrrolidinium tris(pentafluoroethyl)trifluorophosphate, 1-butyl-1-methyl pyrrolidinium bis(trifluoromethylsulfonyl)imide, 1-butyl-3-methyl imidazolium hexafluorophosphate, 1-ethyl-3-methylimidazolium bis(trifluoromethylsulfonyl)imide and 1-n-butyl-3-methylimidazolium. Examples of polar aprotic solvent include, but are not limited to, methyl ethyl ketone, methyl isobutyl ketone, acetone, cyclohexanone, ethyl acetate, isobutyl isobutyrate, ethylene glycol diacetate, dimethylform-amide, acetonitrile, N,N-dimethyl acetamide, nitromethane, acetonitrile, N-methylpyrrolidone, and dimethylsulfoxide. The solvent may be removed after non-covalent or covalent interaction between the amphiphilic polymer and the nanocrystal has been allowed to occur.

In the method of the present invention the nanocrystal is contacted with an amphiphilic polymer according to the invention. As a result, the amphiphilic material is wrapped around the nanocrystal. In one embodiment the nanocrystal has a coordinating solvent via non-covalent interaction on its surface, wherein the solvent may include one or more aliphatic side chains. This coordinating solvent is exchanged for the amphiphilic polymer upon contacting the nanocrystal and the amphiphilic polymer. The amphiphilic polymer is fixed to the nanocrystals via non-covalent or covalent interaction. Such interaction may be, but is not limited to, a coordinative bond, a Casimir interaction, a hydrophobic interaction, hydrogen bonding, a solvation force and a Van-der-Waals interaction.

In one embodiment the amphiphilic polymer is added to the nanocrystal in a suitable solvent. A suitable solvent may be a polar solvent, such as a polar protic solvent. A protic solvent is a solvent that has, for example, a hydrogen atom bound to an oxygen as in a hydroxyl group or a nitrogen as in an amino group. More generally, any molecular solvent which contains dissociable H⁺, such as hydrogen fluoride, is called a protic solvent. The molecules of such solvents can donate an H⁺ (proton). Examples for polar protic solvents include, but are not limited to, water, methanol, ethanol, butyl alcohol, tert.-butyl alcohol, phenol, cyclohexanol, formic acid, acetic acid, dimethylarsinic acid [(CH₃)₂AsO(OH)], aniline, N,N-dimethyl-formamide, N,N-diisopropylethylamine, or chlorophenol. In one embodiment of the present invention water may be used.

In the above procedure any organic solvent provided with the nanocrystal may be replaced by an aqueous solution after being contacted with the amphiphilic polymer of the invention. In one embodiment upon phase transfer to an aqueous solution the remaining anhydride rings are allowed to open, thereby yielding negatively charged carboxyl groups, which provide electrostatic repulsion resulting in a stable dispersion of the nanocrystal(s).

In one embodiment of the present invention the method of forming a water-soluble nanocrystal includes providing a nanocrystal in a suitable solvent. In the method the nanocrystal is contacted with an amphiphilic polymer. The amphiphilic polymer includes a hydrocarbon backbone, which carries (i) polar side groups, (ii) first aliphatic moieties having a main chain of about 3 to about 20 carbon atoms and 0 to about 3 heteroatoms selected from the group N, O, S, Se and Si, and (iii) second aliphatic moieties having a main chain of about 3 to about 80 carbon atoms and 0 to about 40 heteroatoms selected from N and O, the second aliphatic moieties having a copolymerisable group, and; allows non-covalent or covalent interaction between the amphiphilic polymer and the nanocrystal, thereby forming a water-soluble nanocrystal, wherein the definitions are as described above. Thus, with the process of the present invention described above it is possible to transfer nanocrystals into water.

It is possible that the copolymerisable groups of the second aliphatic moieties of the amphiphilic polymer may be cross-linked or reacted with an additional functionalized compound to form a (further) polymer or a polymeric network. This polymerization may be effected in various ways. For example, the copolymerisable group may be allowed to be cross-linked by reacting the amphiphilic polymer with an at least bifunctional (monomeric) compound, wherein two or more functional groups of the at least (monomeric) bifunctional compound are capable of forming a linkage with the copolymerisable groups of the second aliphatic moieties of the amphiphilic polymer. In another embodiment the cross-linking is effected by allowing copolymerisation of the copolymerisable group of the second aliphatic moieties of the amphiphilic polymer to occur with the at least bifunctional compound. At least one of the functional groups of the at least monomeric bifunctional compound is one of an amino group, a hydroxyl group, a thiol group, a selenol group, a halogen, an ether group, a thioether group, an epoxy group, a nitro group, a trihalosilyl group, a terminal C═C bond or a terminal C≡C bond. The at least bifunctional monomeric compound may be water soluble.

In some embodiments the copolymerisable groups of the second aliphatic moieties present in the amphiphilic polymer may be reacted with any further matter such as a molecule or a surface. Such a molecule or surface may for example include one or more functional groups that are capable of undergoing a reaction with the functional group of the copolymerisable groups of the second aliphatic moieties that are included in the amphiphilic polymer. The corresponding reaction may result in the formation of a covalent or non-covalent linkage. A respective molecule may for example be a nucleotide, a nucleic acid molecule, a peptide, a protein, a lipid, a carbohydrate, a drug, a drug precursor, a drug candidate molecule, a drug metabolite, a vitamin, a synthetic polymer, a receptor ligand or a metabolite. A respective molecule may for instance have affinity for selected target matter. Examples of a respective ligand include, but are not limited to, an immunoglobulin, a fragment thereof, a domain antibody such as a diabody, a triabody or a decabody, or a proteinaceous binding molecule with antibody-like functions such as a mutein based on a polypeptide of the lipocalin family, a glubody, a protein based on the ankyrin scaffold or the crystalline scaffold, an AdNectin, a tetranectin, an avimers or a peptoid.

Illustrative examples of suitable monomeric compounds that can be used in this co-polymerization include N-vinylpyrrolidone, an acrylic acid, an acrylic acid ester, an acrylic acid amide or a vinyl ether derivate carrying an amino or a hydroxyl group in addition to the vinyl ether group. The acrylic acid used can, for example, be acrylic acid or methacrylic acid and their derivates such as esters thereof. Suitable acrylic esters have to be water soluble. Examples of suitable acrylic acid esters include, but are not limited to, methyl methacrylate, 5-hydroxymethyl-2(5H)-furanone, 2-hydroxyethyl acrylate, 2-hydroxyethyl methacrylate, or 3-hydroxypropyl acrylate. Further examples may be ethyl methacrylate, n-propyl methacrylate, isopropyl methacrylate, n-butyl methacrylate, sec-butyl methacrylate, isobutyl methacrylate, tert-butyl methacrylate, methyl acrylate, ethyl acrylate, n-propyl acrylate, isopropyl acrylate, n-butyl acrylate, sec-butyl acrylate, isobutyl acrylate, tert-butyl acrylate, The acrylic acid amide can, for example, be acrylamide (IUPAC name 2-propene amide), N-methyl acrylamide, N-ethyl acrylamide, N-n-propyl acrylamide, N-isopropyl acrylamide, N-n-butyl acrylamide, N-sec-butyl acrylamide, N-isobutyl acrylamide, N-tert-butyl acrylamide, N,N-dimethyl methacrylamide N-(hydroxymethyl)acrylamide, maleamic acid or any derivative thereof. In one embodiment the acrylic acid amide is N-isopropylacrylamide. Examples of vinyl ether derivates include monoethanolamine vinyl ether, monopropanol vinyl ether, 1,4-butanediol vinyl ether, 1,5 pentanediol vinyl ether. Other examples include water soluble monomers like vinyl alcohol, 1,4-pentadien-3-ol, 2-methyl-2-propen-1-ol, allyl alcohol, 3-butene-1,2-diol, 2-methylene-1,3-propanediol, trans-2,3-dimethylacrylic acid or 4-styrenesulfonic acid.

Further groups that may be used in the above polymerization reaction may be, but are not limited to, alkene groups, alkyne groups, allyl groups, allyl glycidyl ether groups, alkylalkene groups, alkylalkyne groups, benzoxazinegroups, epoxide groups and oxetane groups.

In one embodiment allowing the copolymerisable group to be cross-linked may be effected by allowing the copolymerisable groups of the second aliphatic moieties of the amphiphilic polymer to cross-polymerize with each other. In another embodiment, the copolymerisable groups are allowed to cross-polymerize with each other without adding an at least bifunctional compound. As a consequence of the additional (cross-) polymerization it is possible that the formation of a polymeric meshwork may be effected. Within this meshwork a plurality of water-soluble nanocrystals may be embedded therein.

The reaction of the amphiphilic polymer with an at least bifunctional compound may be carried out in the presence of a polar protic solvent. The polar protic solvents may be as described above, for example water.

To further support the polymerization reaction a suitable initiator may be added. An initiator may serve for initiating the polymerization reaction. Every initiator known in the state of the art may be used for such purpose. The polymerization can be carried out in accordance with established methodology, for example, by direct mixing of the suitable monomer and the nanocrystals coated with polymer of the present invention (see Example 4 below) or a microemulsion polymerization (see Example 5). Generally, the polymerization reaction is carried out by standard techniques and procedures known to the skilled man in the art.

The invention accordingly also provides a polymer, including a polymer meshwork as described above, which includes one or more nanocrystals. Any nanocrystal may be included in the polymer. Where a plurality of nanocrystals is included in the polymer these nanocystals may be identical, similar or different in chemical structure, composition and/or size.

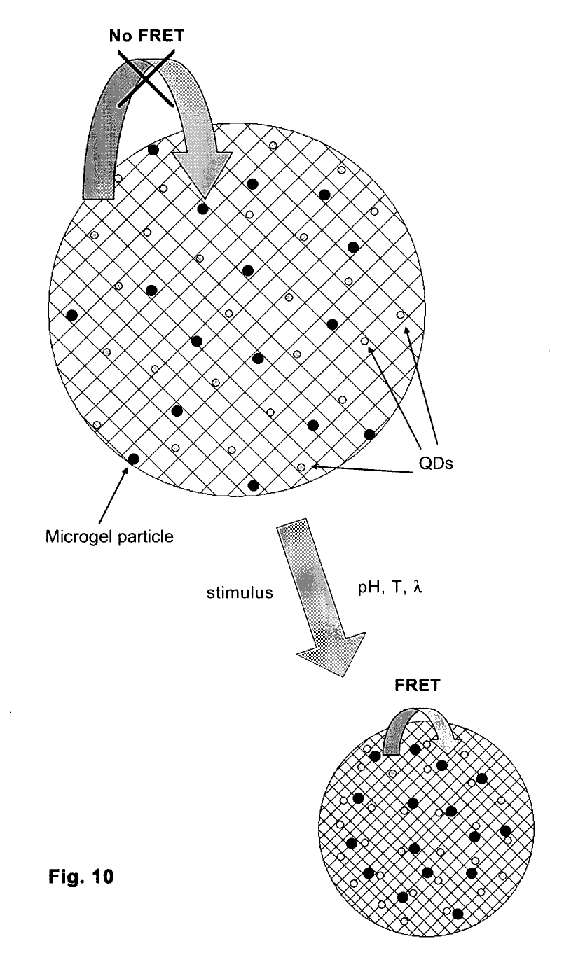

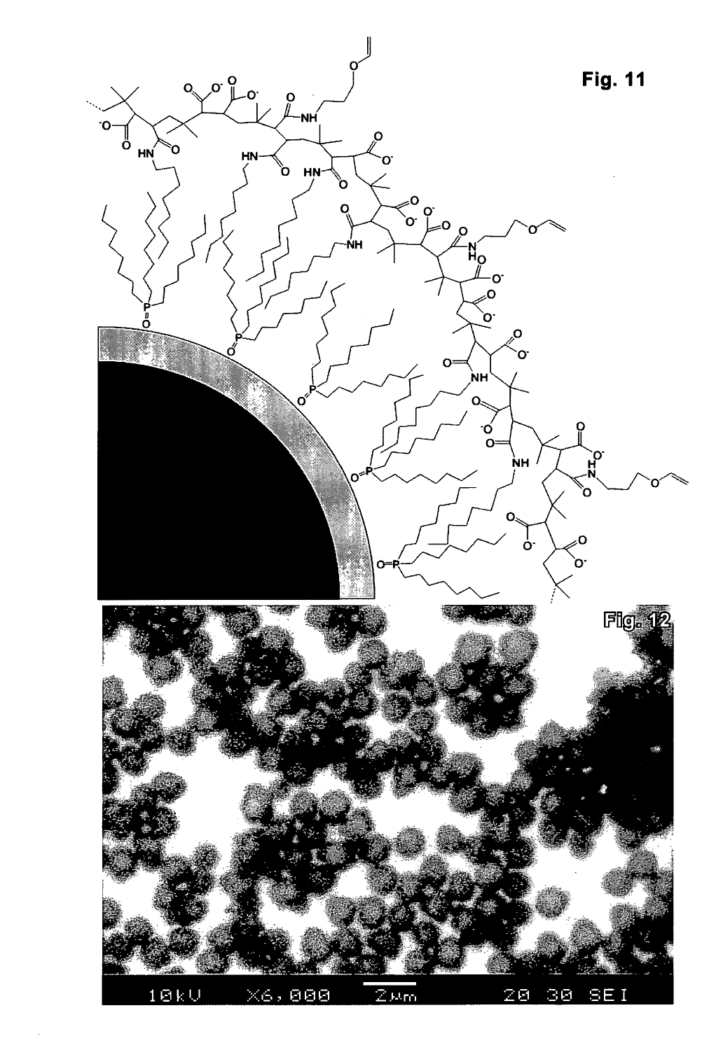

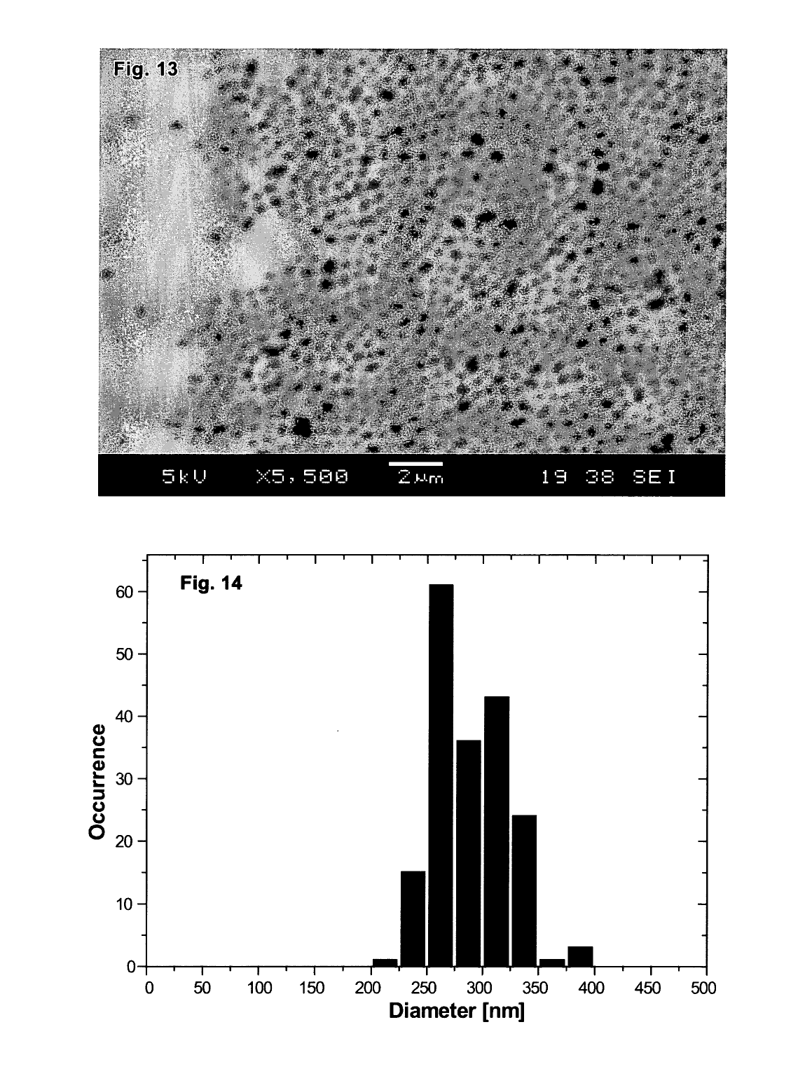

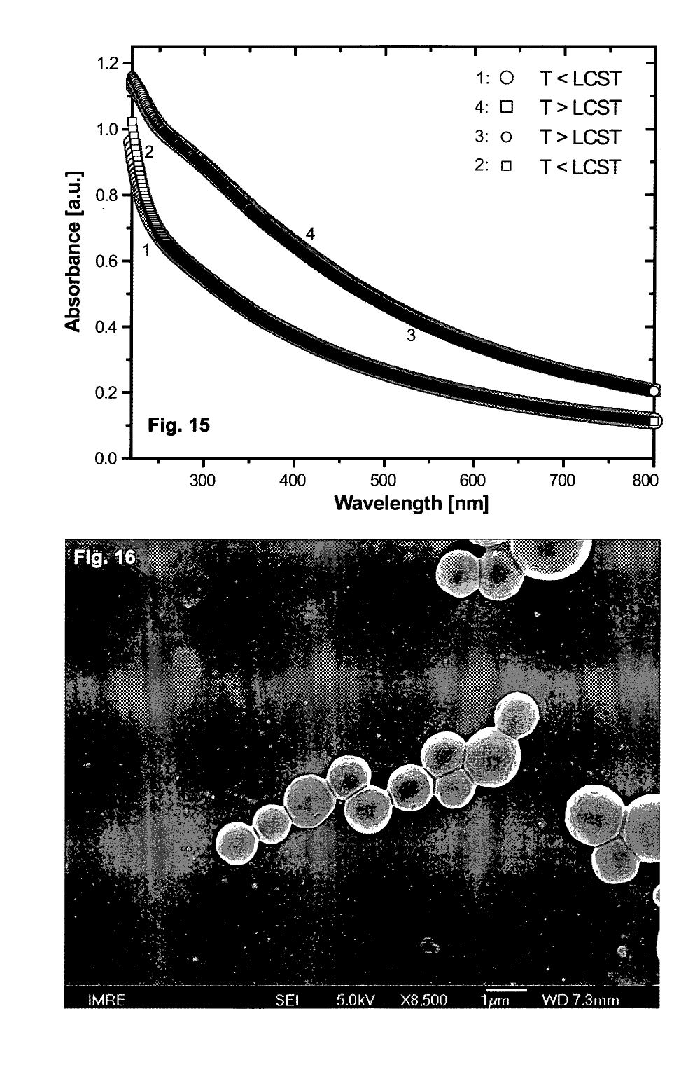

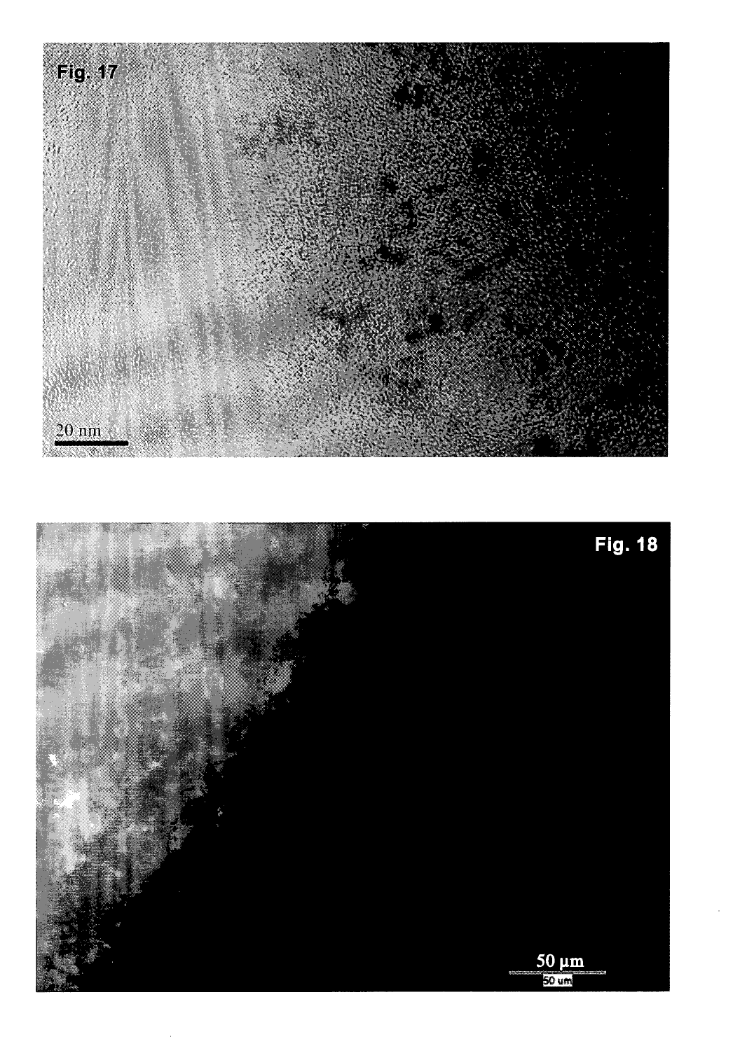

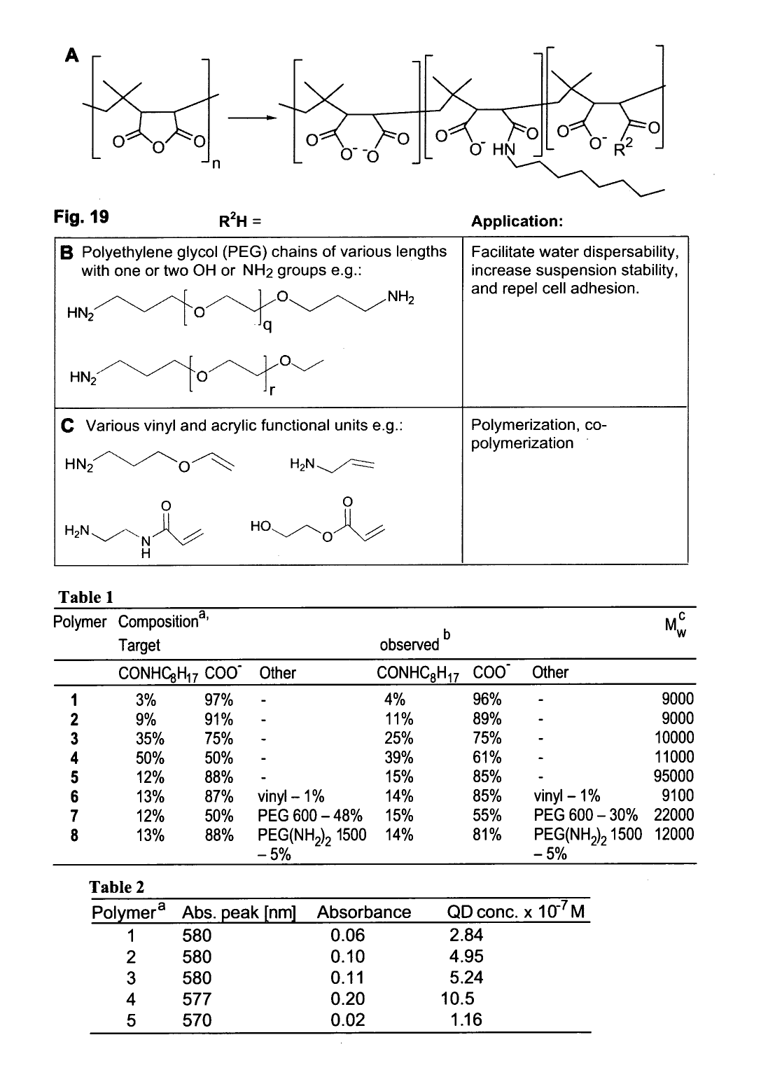

As will be apparent from the above, the polymer, including a polymer meshwork, may have inherent properties such as polarity, packing, conformation or volume that are reversibly modifiable or tunable, for instance in response to a change in the ambience or the medium in which the polymer is provided. Such a change of the ambience or respective medium may for instance be a change in temperature, solution concentration of components of the medium such as ions, or a change in pH (cf. FIG. 10). An illustrative example of such a polymer is a polymer that includes N-isopropyl acrylamide units. Accordingly, a water soluble nanocrystal that has on its surface a respective polymer may likewise be capable of undergoing a change of one or more properties such as size, molecular packing or molecular polarity, including the degree of water solubility. In embodiments where one or more nanocrystals provide photoluminescent properties to such a polymer, the luminescence characteristics may be affected by a change of a property of the polymer. The polymer may thus render luminescence characteristics of such one or more nanocrystals tunable.

The above-mentioned polymer meshwork, wherein for example nanocrystals, as described herein, may be embedded as described above, may provide additional properties to the system, such as stability, solubility properties, increase the processability of the polymers, improve the catalytic properties of the material, and so on. A meshwork in this respect may be a 3-dimensional system. In such a meshwork the amount of nanocrystals in the amphiphilic polymer may be in the range from about 0.01% (v/v) to about 50% (v/v), including from about 0.05% (v/v) to about 50% (v/v), such as about 0.05% (v/v) to about 40% (v/v), about 1% (v/v) to about 30% (v/v), about 1% (v/v) to about 25% (v/v). In one embodiment the amphiphilic polymer in this system has on its surface side chains, the side chains having an alkyl chain of about 3 to about 80 carbon atoms and 0 to about 40 heteroatoms selected from N and O, the side chains having a copolymerisable group, wherein the copolymerisable groups of the second aliphatic moieties are allowed to crosslink, thereby defining the above polymer meshwork. For example, the polymer meshwork may be obtained by reacting the amphiphilic polymer with a bifunctional compound, wherein two or more functional groups of the at least bifunctional compound are capable of forming a linkage with the copolymerisable groups of the second aliphatic moieties of the amphiphilic polymer. In one embodiment the copolymerizable groups of the second aliphatic moieties of the amphiphilic polymer may be cross-polymerized with each other.

The bifunctionality provided by the at least bifunctional moiety having a polymerizable group and thus the possibility of the formation of a polymeric meshwork may be used for applying the nanocrystals of the present invention to various applications.

Among other possible applications, incorporation of vinyl functionalized assemblies into polymeric architectures by copolymerization with vinyl monomers or using the assemblies directly for bio-imaging application may be encompassed.

A water-soluble nanocrystal according to the present invention may conveniently be used within a microorganism, in particular a cell. The presence of the amphiphilic polymer allows internalization into a respective microorganism, including a cell. Depending on any moiety or molecule that may be linked to the copolymerisable groups of the second aliphatic moieties of the amphiphilic polymer the water-soluble nanocrystal may also be directed to a selected intracellular compartment, structure, organelle or other location. The amphiphilic polymer used may also include groups or moieties that are capable of directing the respective nanocrystal to a selected intracellular location. In typical embodiments where any such molecule or moiety with a location-directing function such as an immunoglobulin, or a fragment thereof, or a ligand of a receptor, is absent and the water-soluble nanocrystal is allowed to enter a cell the nanocrystal is at least largely locating inside the cytoplasm. Where the polymer for example includes multivalent amine groups, a corresponding water-soluble nanocrystal is capable of disrupting endosomal organelles (Duan, H., & Nie, S., J. Am. Chem. Soc. (2007) 129, 11, 3333-3338). Cytotoxic effects typically observed with nanocrystals can be avoided with a respective selection of the water-soluble polymer. This is due to the fact that cytotoxicity is dependent on the molecules present on the surface of a nanocrystal rather than the nanocrystal itself (Hoshino, A., et al., Nano Letters (2004) 11, 2163-2169). Accordingly a nanocrystal, e.g. quantum dot, according to the present invention may be used in a variety of biological and medical applications, including as an intracellular probe, for instance for immunofluorescence or ultrastructural imaging (see e.g. King, J., et al., Microsc. Microanal. (2008) 14, Suppl 2, 702-703).

In another embodiment the present invention may refer to a nanocrystal, as disclosed herein, that is conjugated to a molecule having binding affinity for a given analyte. Such conjugation may be affected via the polymeric meshwork formed with the inventive system. By conjugating the nanocrystal to a molecule having binding affinity for a given analyte, a marker compound or probe is formed. In such a probe, the nanocrystal of the invention serves as a label or tag which emits radiation, for example in the visible or near infrared range of the electromagnetic spectrum that can be used for the detection of a given analyte.

In principle any analyte can be detected for which a specific binding partner exists that is able to at an at least certain degree specifically bind to the analyte. The analyte can be a chemical compound such as a drug (e.g. Aspirin®) or Ribavirin), or a biochemical molecule such as a protein (for example, an antibody specific for troponin or a cell surface protein) or a nucleic acid molecule. When coupled to an appropriate molecule with binding affinity (which is also referred to as the analyte binding partner) for an analyte of interest, such as Ribavirin, the resulting probe can be used for example in a fluorescent immunoassay for monitoring the level of the drug in the plasma of a patient. Another example is a conjugate of the nanocrystal with streptavidin.

The analyte can also be a complex biological structure including, but not limited to, a virus particle, a chromosome or a whole cell. For example, if the analyte binding partner is a lipid that attaches to a cell membrane, a conjugate comprising a nanocrystal of the invention linked to such a lipid can be used for detection and visualization of a whole cell. For purposes such as cell staining or cell imaging, a nanocrystal emitting visible light is preferably used. In accordance with this disclosure the analyte that is to be detected by use of a marker compound that comprises a nanoparticle of the invention conjugated to an analyte binding partner is preferably a biomolecule.

Therefore, in a further embodiment, the molecule having binding affinity for the analyte is a protein, a peptide, a compound having features of an immunogenic hapten, a nucleic acid, a carbohydrate or an organic molecule. The protein employed as analyte binding partner can be, for example, an antibody, an antibody fragment, a ligand, avidin, streptavidin or an enzyme. Examples of organic molecules are compounds such as biotin, digoxigenin, serotronine, folate derivatives, antigens, peptides, proteins, nucleic acids and enzymes and the like. A nucleic acid may be selected from, but not limited to, a DNA, RNA or PNA molecule, a short oligonucleotide with 10 to 50 by as well as longer nucleic acids.

In another embodiment of the present invention a dye may be directly attached to the amphiphilic polymer used to make the nanocrystal water soluble. Different sorts of dyes may be attached depending on the specific use of such a dye-nanoparticle system. For example, cellular traffic on a single particle level may be monitored with such systems.

In a further embodiment, the polymeric material bearing coated quantum dots with polymerizable functions may be used for the formation or immobilization of films on various substrates, such as silicon, glass, quartz and so on. Such immobilization or filmcoating may be used in any technical field wherein such modification is necessary or suitable.

As already indicated above, a water-soluble nanocrystal and a polymer, including polymer meshwork including one or more nanocrystals according to the present invention may be used in a variety of applications. Illustrative examples of such applications are biolabelling, bioimaging, physical sensing, chemical sensing, the formation of light-emitting devices and solar cells, amplified spontaneous emission, catalysis, the formation of high refractive index materials and the formation of electrode coatings.

In order that the invention may be readily understood and put into practical effect, particular embodiments will now be described by way of the following non-limiting examples.

### Examples

### Example 1

### Synthesis of Quantum Dots—General Procedure

All reagents were purchased from Aldrich or Fluka, including poly(isobutylene-altmaleic anhydride) (Mw=6000 and 60000 g/mol). NMR spectra were recorded on a Bruker 400 MHz spectrometer. UV-VIS absorption was recorded using a Shimadzu spectrophotometer (UV-1601). A Shimadzu spectrofluorometer (RF-5301PC) was used to obtain the luminescence spectra of the QD solutions.

Cadmium oxide (0.026 g, 0.20 mmol) and stearic acid (0.25 g, 0.88 mmol) were dried in vacuum and subsequently heated in N₂ atmosphere till 220° C. until solution become transparent. Mixture was cooled to room temperature and subsequently TOPO (4.00 g, 50 mmol) followed by 1 hexadecylamine (2.50 g, 500 mmol) were added. The mixture was warmed till 220-240° C. and solution of Se in TOP (0.2 mL, 0.2 mmol) was added. To grow the passivating ZnS layer around the CdSe core, solution of sulphur in TOP (0.2 mL, 0.2 mmol) was added alternately with solution of Et₂Zn in hexane/TOP (1 mL, 0.2mmol) in few small portions. The size and size distribution of the nanocrystals was controlled by temperature and time between the addition of Se solution and first portion of S.

### Example 2

### General Procedure for Synthesis of Polymers 1-8

To the solution of 1 g poly(isobutylene-alt-maleic anhydride) in 300 mL of dry CHCl₃ the respective amine followed by DIPEA (1 mL) were added and the mixture was stirred for 16 h in 50° C. In cases of polymers 6-8 the second component was added 2 h after the initial n-octylamine addition, i.e. in a one-pot reaction. After evaporation of CHCl₃ the material was suspended in water with small excess of NaOH toward the carboxylic groups in the polymer backbone. After evaporation of water and DIPEA, remain was dissolved in water and dialyzed against water for a few days. The solution after alkalization to pH 11 with 1 M NaOH and subsequent evaporation resulted with products. The poly(isobutylene-alt-maleic anhydride) reacts spontaneously with high yield with both the monofunctional compound and the at least bifunctional compound (here the second component).

In the following exemplary data on the formation of a series of amphiphilic polymers of interest 1-5 are provided. Following the foregoing protocol these amphiphilic polymers were synthesised by grafting n-octylamine to poly(isobutylene-alt-maleic anhydride) at different molar ratios (cf. also Table 1). To introduce additional functional units onto the QD/polymer assemblies, polymers containing vinyl function 6 and different PEG oligomers 7-8 were synthesised as well.

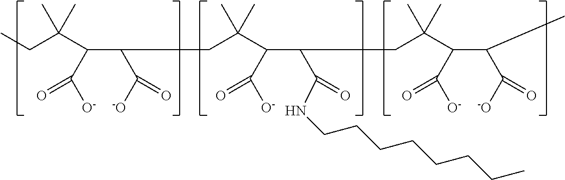

Reaction of poly(isobutylene-alt-maleic anhydride 6000 with octylamine (0.05 g, 0.4 mmol) resulted with crystalline product 1 (0.86 g, 59%). ¹H-NMR (400 MHz, D₂O) δ: 3.25-2.90 (m, 9H), 2.59 (bs, 39H), 2.08 (bs 39H), 1.95-1.35 (m, 81H), 1.34 (bs, 62H), 1.13-0.65 (m, 238H). Target composition: carboxylic 97%, octyl amide 3%; observed: carboxylic 96%, octyl amide 4%.

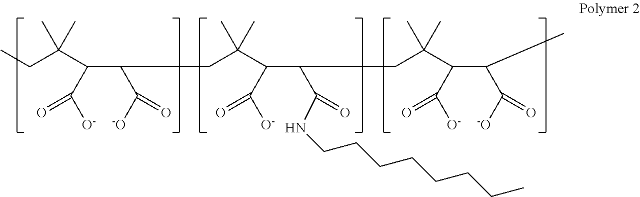

Reaction of poly(isobutylene-alt-maleic anhydride 6000 with octylamine (0.15 g, 1.2 mmol) resulted with crystalline product 2 (0.97 g, 64%). ¹H-NMR (400 MHz, D₂O) δ: 3.30-2.90 (m, 23H), 2.59 (bs, 38H), 2.42-1.40 (m, 152H), 1.23 (bs, 116H), 1.15-0.70 (m, 238H). Target composition: carboxylic 91%, octyl amide 9%; observed: carboxylic 89%, octyl amide 11%.

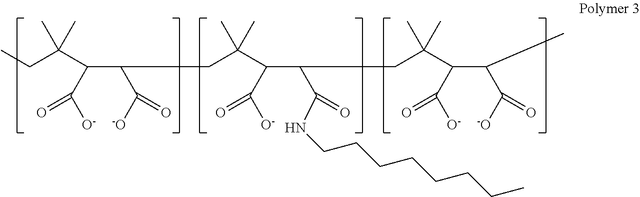

Reaction of poly(isobutylene-alt-maleic anhydride 6000 with octylamine (0.42 g, 3.2 mmol) resulted with crystalline product 3 (1.06 g, 63%). ¹H-NMR (400 MHz, D₂O) δ: 3.28-2.85 (m, 47H), 2.60 (bs, 37H), 2.41-1.60 (m, 81H), 1.47 (bs, 68H), 1.24 (bs, 253H), 1.12-0.75 (m, 286H). Target composition: carboxylic 75%, octyl amide 25%; observed: carboxylic 75%, octyl amide 25%.

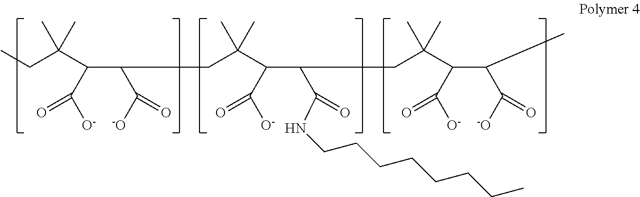

Reaction of poly(isobutylene-alt-maleic anhydride 6000 with octylamine (0.84 g, 6.5 mmol) resulted with crystalline product 4 (1.63g, 88%). ¹H-NMR (400 MHz, D₂O) δ: 3.25-2.85 (m, 72H), 2.60 (bs, 34H), 2.40-1.65 (m, 73H), 1.48 (bs, 87H), 1.24 (bs, 379H), 1.12-0.65 (m, 317H). Target composition: carboxylic 50%, octyl amide 50%; observed: carboxylic 61%, octyl amide 39%.

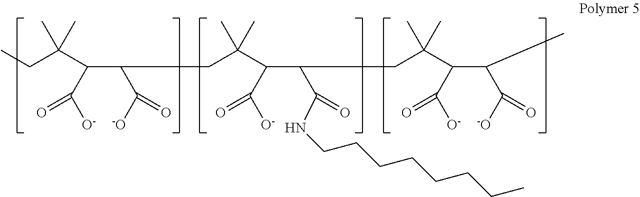

Reaction of poly(isobutylene-alt-maleic anhydride 60000 with octylamine (0.21 g, 1.6 mmol) resulted with crystalline product 5 (1.49 g, 95%). ¹H-NMR (400 MHz, D₂O) δ: 3.25-2.85 (m, 33H), 2.62 (bs, 43H), 2.40-1.65 (m, 89H), 1.49 (bs, 76H), 1.25 (bs, 159H), 1.12-0.65 (m, 262H). Target composition: carboxylic 88%, octyl amide 12%; observed: carboxylic 85%, octyl amide 15%.

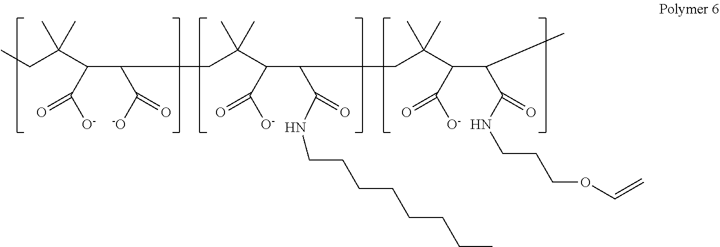

Reaction of poly(isobutylene-alt-maleic anhydride 6000 with octylamine (0.21 g, 1.6 mmol) and 3-amino1-propanol vinyl ether (0.02 g, 0.20 mmol) resulted with crystalline product 6 (0.91 g, 60%). ¹H-NMR (400 MHz, D₂O) δ: 6.42 (bs, 1.5H), 4.25 (bs, 1.5H), 4.04 (bs, 1.5H), 3.78 (bs, 3H), 3.25-2.82 (m, 30H), 2.80-1.60 (m, 154H), 1.45 (bs, 45H), 1.29 (bs, 144H), 1.14-0.65 (m, 258H). Target composition: carboxylic 87%, octyl amide 12.5%, vinyl 1.5%; observed: carboxylic 85%, octyl amide 13%, vinyl 1.8%.

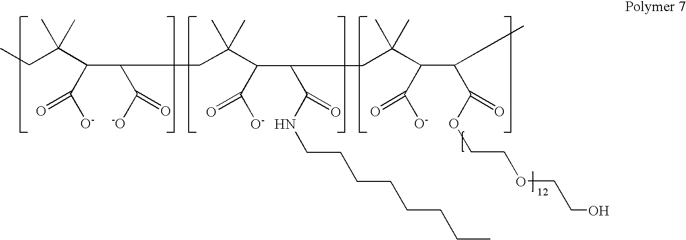

Reaction of poly(isobutylene-alt-maleic anhydride 6000 with octylamine (0.21 g, 1.6 mmol) and PEG 600 (11.6 g, 19 mmol) resulted with glassy product 7 (3.20 g, 86%). ¹H-NMR (400 MHz, D₂O) δ: 4.20-3.98 (m, 13H), 3.82-3.40 (m, 1191H), 3.26-3.86 (m, 17H), 2.80-1.60 (m, 165H), 1.47 (bs, 48H), 1.22 (bs, 189H), 1.14-0.68 (m, 262H). Target composition: carboxylic 50%, octyl amide 12%, PEG 48%; observed: carboxylic 55%, octyl amide 15%, PEG 30%.

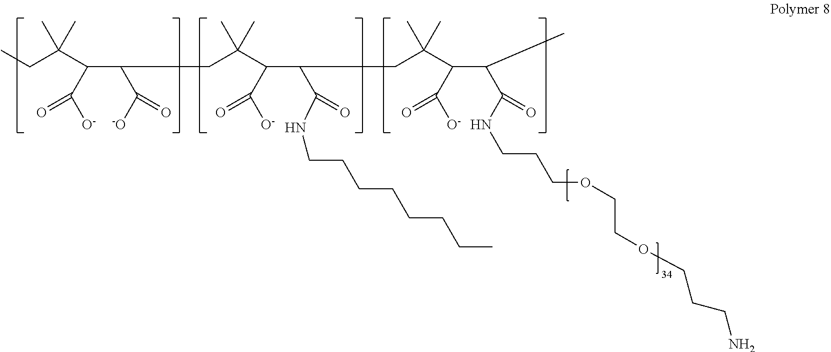

Reaction of poly(isobutylene-alt-maleic anhydride 6000 with octylamine (0.21 g, 1.6 mmol) and diaminopropyl PEG 1500 (0.50 g, 0.33 mmol) resulted with crystalline product 8 (1.58 g, 78%). ¹H-NMR (400 MHz, D₂O) 5: 3.78-3.42 (m, 270H), 3.25-3.82 (m, 30H), 2.80-1.60 (m, 128H), 1.48 (bs, 48H), 1.22 (bs, 151H), 1.12-0.70 (m, 260H). Target composition: carboxylic 88%, octyl amide 13%, PEG 1500 5%; observed: carboxylic 81%, octyl amide 14%, PEG 1500 5%.

To identify properly the composition of the polymers obtained, NMR spectra were confronted with NMR of poly(isobutylene-alt-maleic anhydride) backbone opened by treatment with stechiometric amount of NaOH to carboxyl groups. NMR integration was normalized to the backbone 6000 g/mol (n=38). Weight average molar mass was calculated based on the NMR spectra of purified polymers.

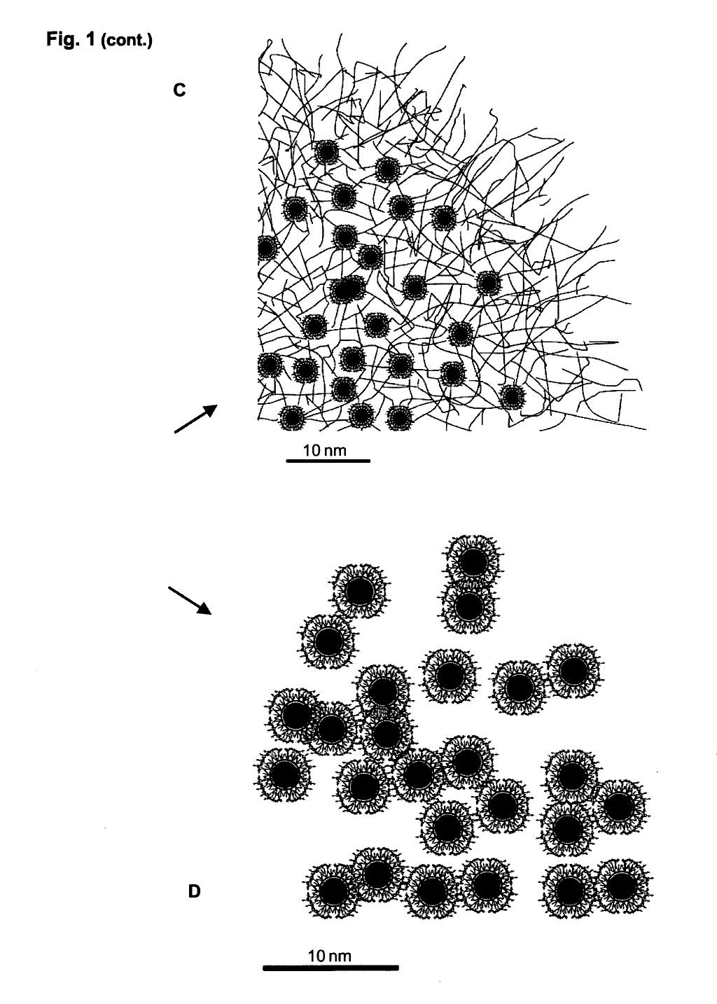

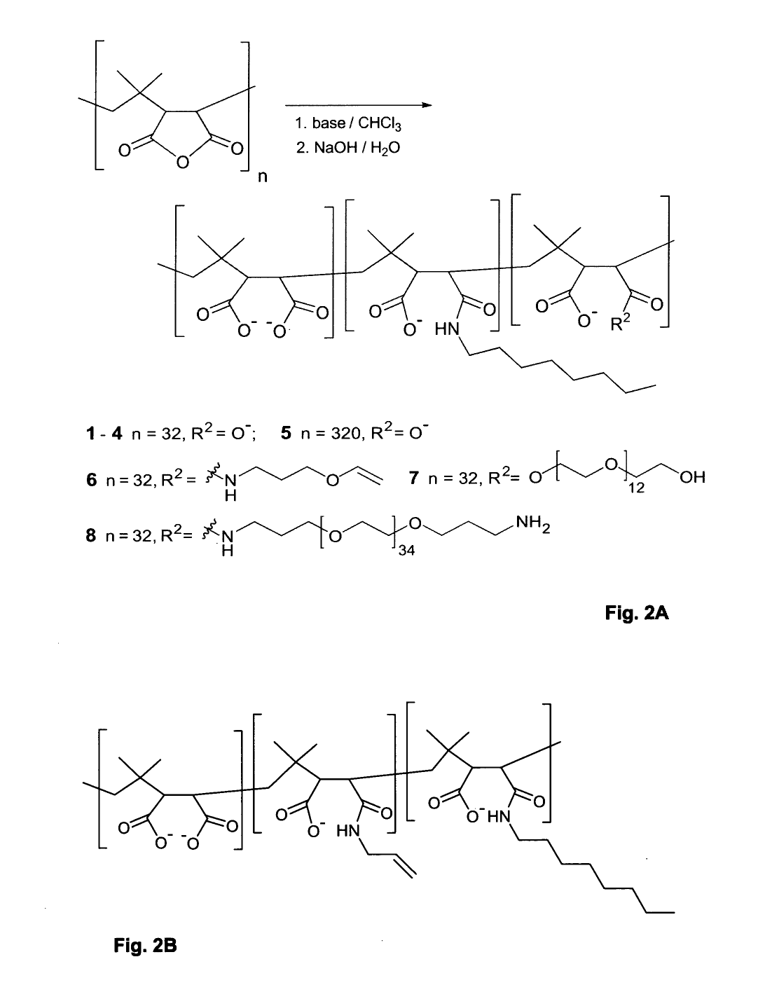

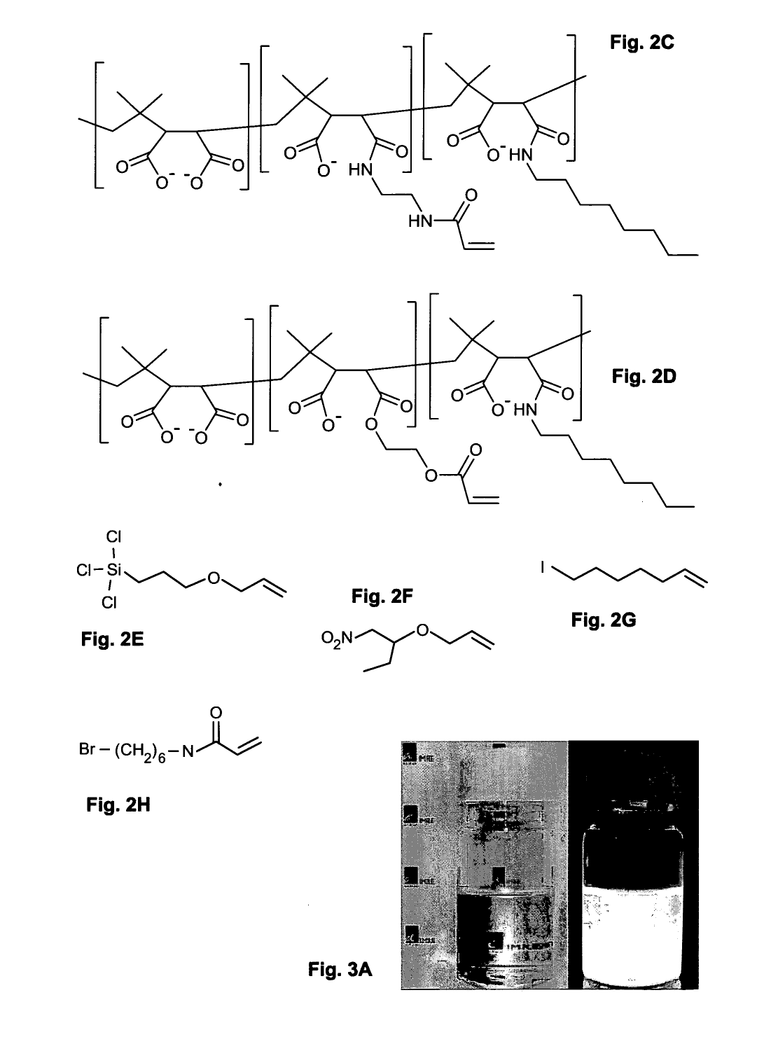

Polymers as depicted in FIG. 2B to FIG. 2D can be synthesized in a manner similar as described above by grafting appropriate amine (octyl amine, and amines bearing vinyl or acryl function) into an anhydride polymeric backbone.

Control over the number of hydrophobic units with respect to the number of carboxyl groups in the backbone of polymers 1-8 was achieved by changing the amount of nucleophilic reactants used for the reaction with the polyanhydride chain (see polymers 1-4, cf. also FIG. 2A).

### Example 3

### Synthesis of QD/Polymer Assemblies

2 mg of purified QDs were dissolved in THF (2 mL) and 0.5 mL of 1.4 mM polymer solution was added followed by 5 mL of water. The mixture was concentrated with a rotary evaporator to 1 mL. Turbid water suspension was filtered trough a 0.8 μm filter and the filter was washed with 5 mL of pure water. The supernatant was filtered again according to the same procedure through a hydrophilic filter (0.2 μm) resulting in a clear QDs water solution. Excess of water can be removed with a rotary evaporator to reach desirable concentration.

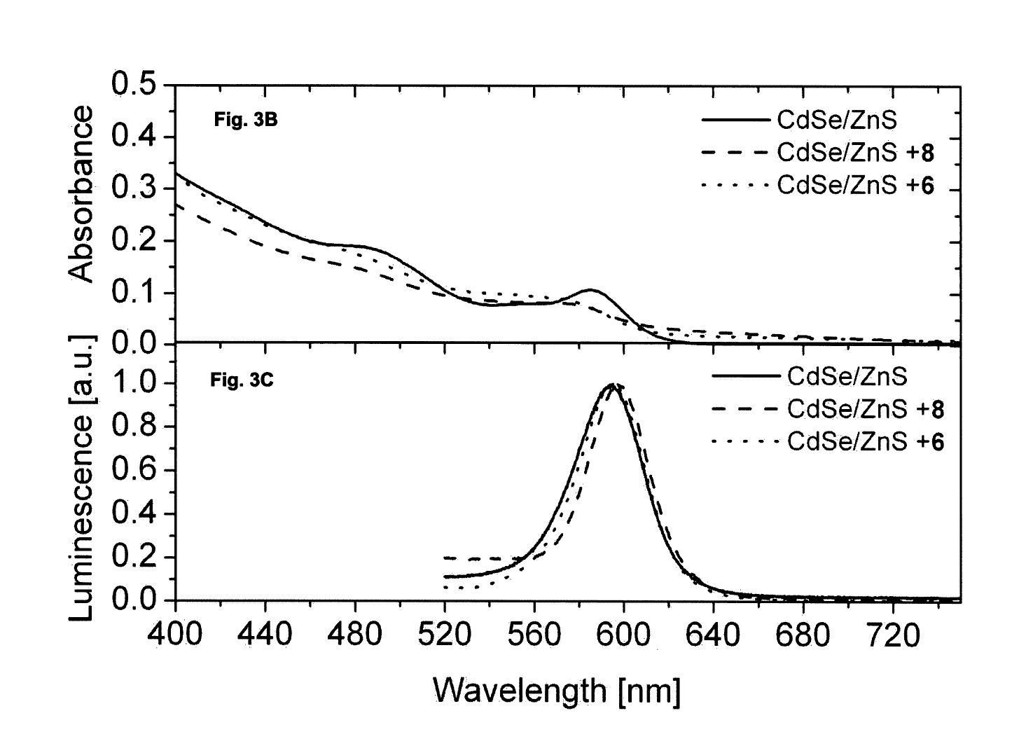

The above described polymers 1-8 were used to transfer nanocrystals into water. Based on the absorption of QD/polymer assemblies it is estimated that from 10 to 80% of dots is passing the suspension procedure. This yield is however strongly dependent on polymer used and even more dependent on the purity of the QDs (excess of hydrophobic ligands lead to formation of aggregates). The suspending efficiency of polymers 1-5 was subsequently tested. Starting with the same initial amount of QDs in THF, the same concentration of polymers 1-5 in water has been applied, but different concentrations of QDs in water (calculated from optical absorption) were obtained. The final concentration of QDs in water depends on the ability of a given polymer to suspend QDs in water. It is found that polymer with higher number of n-octyl groups attached to the polymer backbone (Table 2) is more favourable, and this follows a general observation that a higher number of anchoring points (in this case hydrophobic n-octyl chains) gives higher stability to an assembly based on hydrophobic-hydrophobic interactions. For the polymer 5, with a 10 times higher molar mass value than for 1-4, low concentration of QDs in the final aqueous solution can be attributed to the formation of aggregates (few dots attracted to the same polymer chain), and to problems related to the filtration step. Careful purification to remove TOPO, TOP and hexadecylamine in the QDs solution is critical for the effective formation of stable QD/polymer assemblies. Probably the remaining alkyl ligands prevent the formation of monodispersed micelles, as well as drive flocculation. Coating the QDs with polymers and transferring them into water did not show any significant effects on their basic luminescence properties. Although the absorption spectrum shows minor changes, the wavelength at the maximum of the emission and the widths of the emission spectra remain essentially unchanged (FIG. 3).

QDs Coating

Covering hydrophobic QDs (ID no. 200709) (for example TOPO coated CdSe/ZnS Quantum Dots) is carried out by suspending them in THF and subsequent addition of aqueous polymer solution. Removing of THF by evaporation results with stable colloidal solutions of polymer coated Quantum Dots. The resulting solutions are clear, transparent, and display long-term optical and colloidal stability. It is noted that the coating process can generally be carried out on any nanoparticulate matter, regardless of the surface thereof.

### Example 4

### NIPAM Quantum Dots Copolymerization

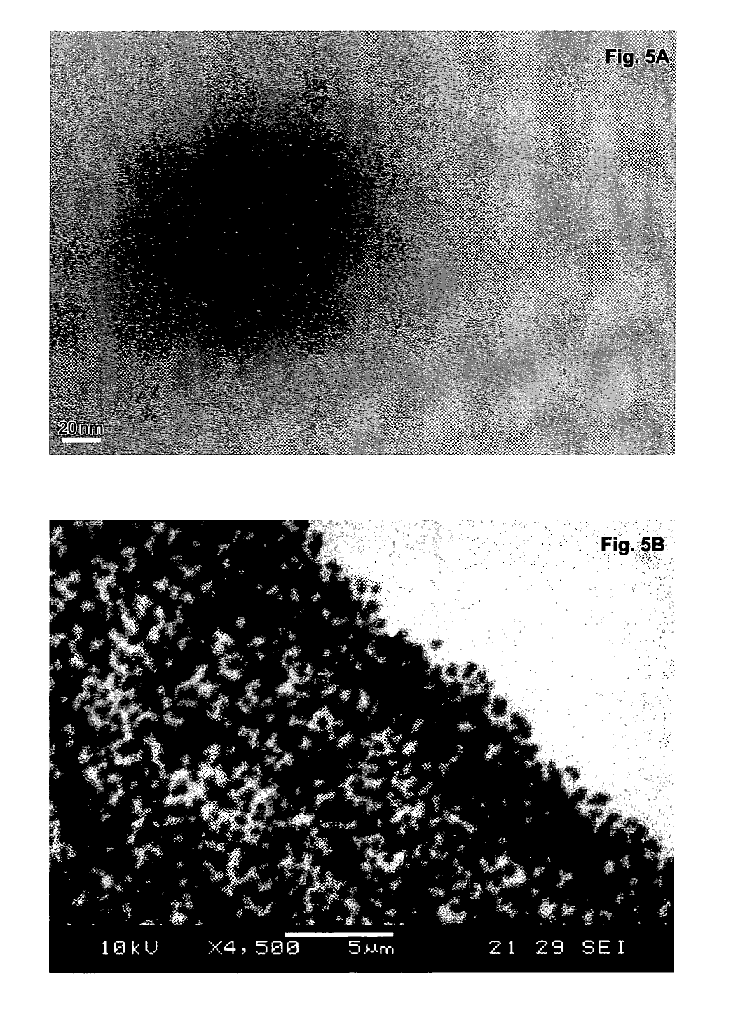

Polymerization is carried by direct mixing of acrylic monomer and QDs coated with polymer such as those depicted in FIG. 2B to FIG. 2D in water or by dosing one of the ingredient to the solution of another in presence of appropriate initiator. Depending on the polymer used (see FIG. 2B to FIG. 2D) and reaction conditions (for example temperature, initiator, concentration of ingredients) different size of microspheres with different number of embedded QDs covalently attached to the polymer chains are possible to obtain. FIG. 5 depicts different representative microscopic images of PNIPAM/QDs composites.

Representative Polymerization Procedure:

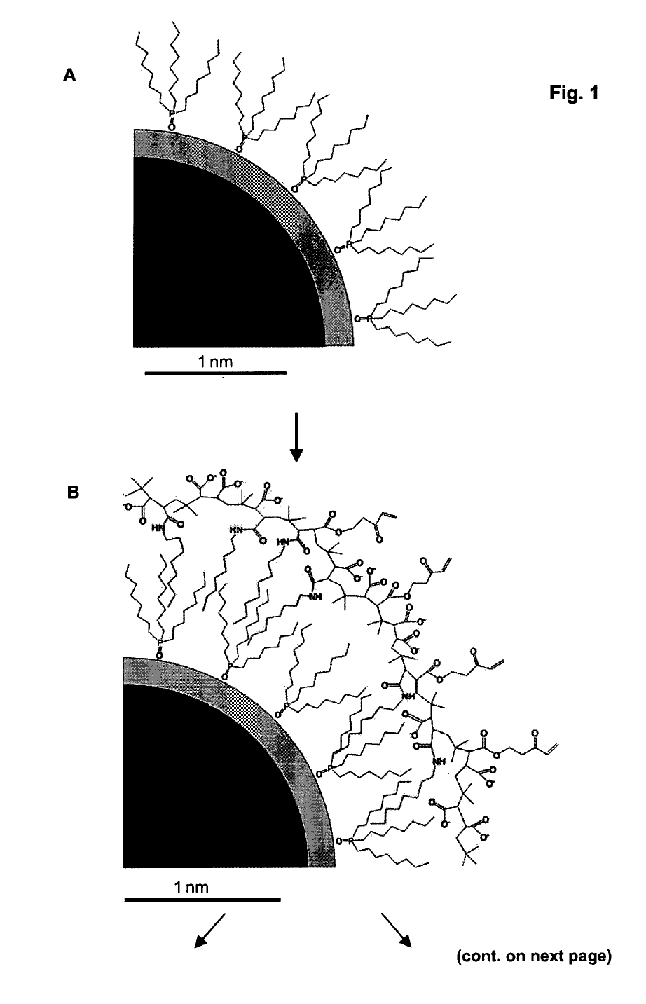

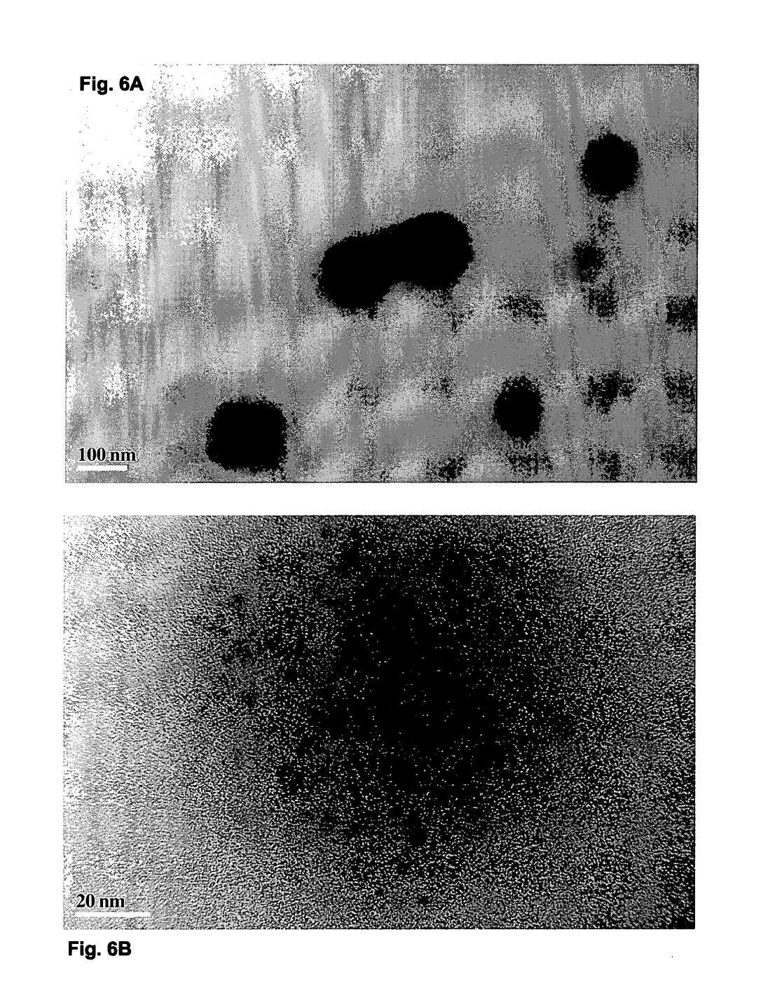

In the 50 mL three neck flask NIPAM (0.0503 g), solution of QDs (8 mg) coated with acrylic ester polymer—ammonium salt form (FIG. 1C) and 20 mL of water was deoxidized by 15 times vacuum/argon evacuation. Temperature was increased to 70° C. and initiator K₂S₂O₈ (0.0319 g in 1 mL of H₂O) was added. Subsequently solution of crosslinker MBAAM (0.0285 g) and NIPAM (0.2526 g) in 4 mL of H₂O was dosed within 75 min. After dosing mixture was kept in 71° C. for additional 4h and cooled to r.t. Purification was carried out by dialysis (50 kD membrane) and centrifuged to remove bigger particles. As a result, water solution of submicroparticles of PNIPAM bearing QDs were obtained. (FIG. 6).

Direct Cross-Polymerization of Quantum Dots

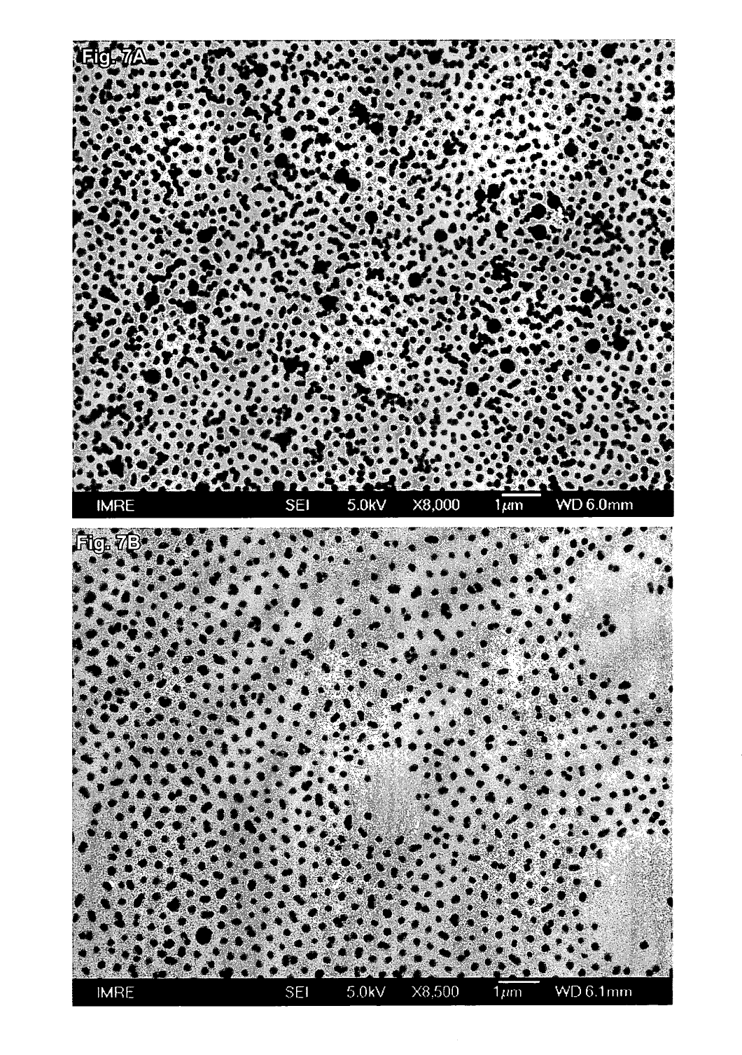

Polymerization is carried by addition of initiator (like K₂S₂O₈) to water solution of dots coated with polymerizable amphiphilic polymer such as those depicted in FIG. 2B to FIG. 2D (FIG. 1). Dialysis of the crude reaction mixture results in water-processable and suspendable solid polymeric film carrying high content of QDs (FIG. 8).

Representative Polymerization Procedure:

In 50 mL flask solution of QDs (8 mg) coated with acrylic amide polymer—sodium salt form (FIG. 1B) and 20 mL of water was deoxidized by 15 times vacuum/argon evacuation. Temperature was increased to 70° C. and initiator K₂S₂O₈ (0.0319 g in 1 mL of H₂O) was added. Temperature of the reaction was maintained for 6 h. Purification was carried by dialysis (50 kD membrane). Purification resulted with water soluble polymeric network bearing high concentration of QDs (FIG. 7).

### Example 5

### Micro-Emulsion Polymerization and Copolymerization of QDs

Polymeric material bearing coated QDs (such as described in Examples 1-3) with polymerizable functions (such as described in Example 4) is used for self polymerization and copolymerization with other water soluble monomers in reversed microemulsion process. Microsphere with controllable diameters in the range between 400 nm and 10 μm are obtained. The microspheres are luminescent over an extended period of time.

Representative Polymerization Procedure of Microemulsion Polymerization:

Argon was passed through solution of sorbitan monooleate (Span 80, 0.23 g) in 10 mL of parafin oil for 1 h. Water solution 1 mL in volume, containing NIPAM (0.15 g, 1.32 mmol), N,N′methylenebisacrylamide (0.013 g, 0.06 mmol), 8 mg of QDs and 10 mg of polymers (liken in 1.3.2) were added to oil phase and argon bubbling was continued for next 1 h. Emulsion was sonicated for 1 min in 40° C. and then was shaken for 1 h in r.t. with laboratory vortex shaker. Stable homogeneous emulsion was casted onto a Petri dish and irradiated with UV lamp under nitrogen-ventilated crosslinker device for 4 h at a temperature between 5 and 15° C. and subsequently left without irradiation for 16 h in the inert atmosphere. Purification of PNIPAM latex was carried out by several washing steps and centrifugation with hexane, and subsequently several washing steps and centrifugation with water.

### Example 6

### Formation of Thin Films Bearing QDs

Polymeric material bearing coated QDs (like described in 1.1) with polymerizable functions (like described in 1.2) is used for formation of films on various substrates, like for example: silicon, glass, quartz etc. Films can be formed in various ways, for example by spin coating or drop casting, and later cross-polymerized applying various polymerization techniques, like for instance UV or thermally initiated polymerization.

Representative Polymerization Procedure of Film Polymerization—UV Polymerization:

Water solution 1 mL in volume, containing NIPAM (0.15 g, 1.32 mmol), N,N′methylenebisacrylamide (0.013 g, 0.06 mmol), 8 mg of QDs and 10 mg of polymers (like in 1.2) was drop casted onto a glass surface functionalized with 3-(Trimethoxysilyl)propyl methacrylate. The glass slide was irradiated with UV for 6 h resulting with polymeric film maintaining fluorescent properties.

### Example 7

### AFM and TEM Experiments

The samples for AFM imaging were prepared by drop casting diluted QD/polymer solutions onto 1×1 cm² pieces of cleaned silicon wafer. The substrates were rinsed with destilled water to remove excess of material. The samples were left to dry in air and subsequently mounted on a magnetic metal puck. Imaging of the polymer-coated QDs was performed with a Multimode Atomic Force Microscope (Veeco-Digital Instruments, Santa Barbara, Calif.) equipped with a Nanoscope IV controller. Single beam Si cantilevers (Pointprobe-plus, Nanosensors, Germany) were used for imaging in the tapping mode.

For Transmission Electron Microscopy (TEM) the solutions were drop-casted onto a copper grid coated with a carbon film and let dry in air. Imaging was performed on a JEOL 2100 TEM at 200 kV.

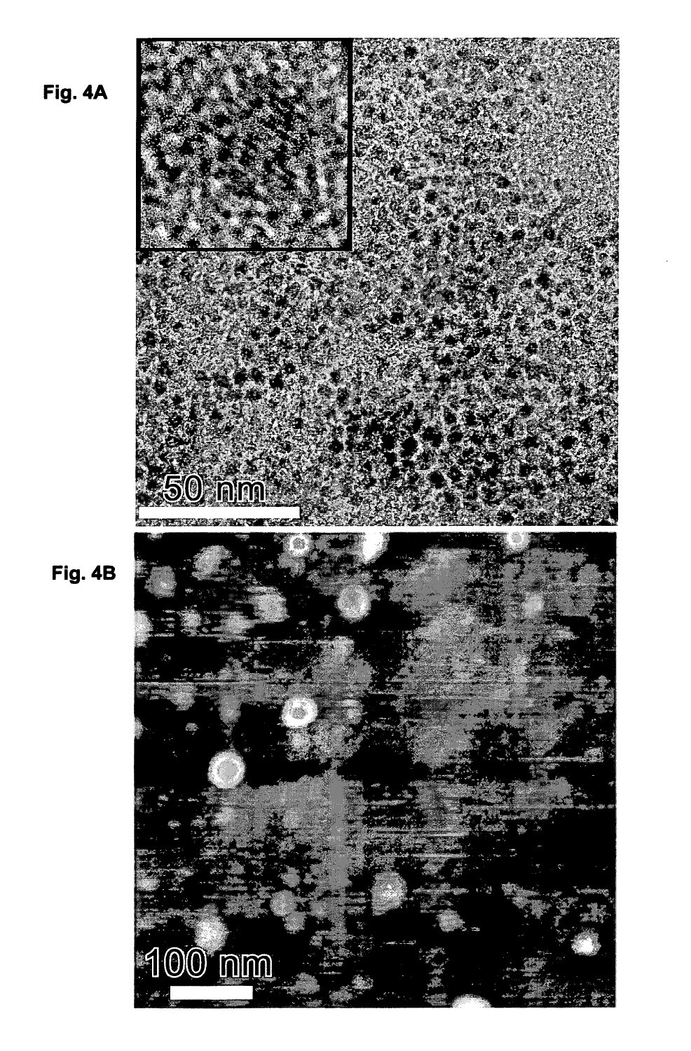

TEM was used to observe individual polymer-coated quantum dots (FIG. 4A). High resolution image (inset) resolves atomic interference fringes of one highly crystalline water-soluble QD. Lower resolution image (FIG. 4A) shows that the polymer-coated QDs did not form large aggregated structures in solution. An atomic force microscopy (AFM) height image (FIG. 4B) of the QD/polymer assemblies on a silicon substrate deposited from a highly diluted solution shows their spherical shape. The height of the structures is in the range between 4 to 6 nm, which corresponds roughly to the size of the QDs coated with a polymer shell. The lateral dimensions of the polymer coated QDs can be significantly broadened by tip related effects.

### Example 7a

### Cells Internalization—Cell Culture

Human breast cancer cells, MCF-7 (ATCC) and rat glioma cells, C6 (ATCC) were cultured at 37° C. in a humidified atmosphere of 5% CO₂ environment and maintained in DMEM medium supplemented with 10% FBS and 1% penicillin-streptomycin solution. The culture medium was replenished every other day. To study cell uptake of particles, cells were seeded at 2.0×10⁴ cells/cm² in Lab-Tek chambered cover glasses (Nunc).

### Example 7b

### Cells Internalization—Uptake of QDs/Polymer Assemblies in Live Cells

The cellular uptake of assemblies of quantum dots embedded in the polymer depicted in FIG. 2C was initiated when the culture medium was replaced by the medium containing 1 mg/ml of the particles of interests in solution which pH was adjusted to 9 prior to dilution. Cell monolayer was further incubated for 1 h at 37° C. At the end of incubation time, the cells were washed 3 times with fresh pre-warmed PBS buffer to eliminate excess particles which were not associated to the cells. Cells were then fixed with 70% ethanol. To assess whether the particles had entered the cytoplasm of cells, nuclei were stained using DAPI to facilitate locate the particles in the cells. The samples were then mounted in the fluorescent mounting medium (Dako). Confocal fluorescent microscopy was performed using an Olympus FV500 system supported with a 60× water-immersion objective. Images were captured in section of 1024×1024 pixels and processed by FV10-ASW 1.3 Viewer.

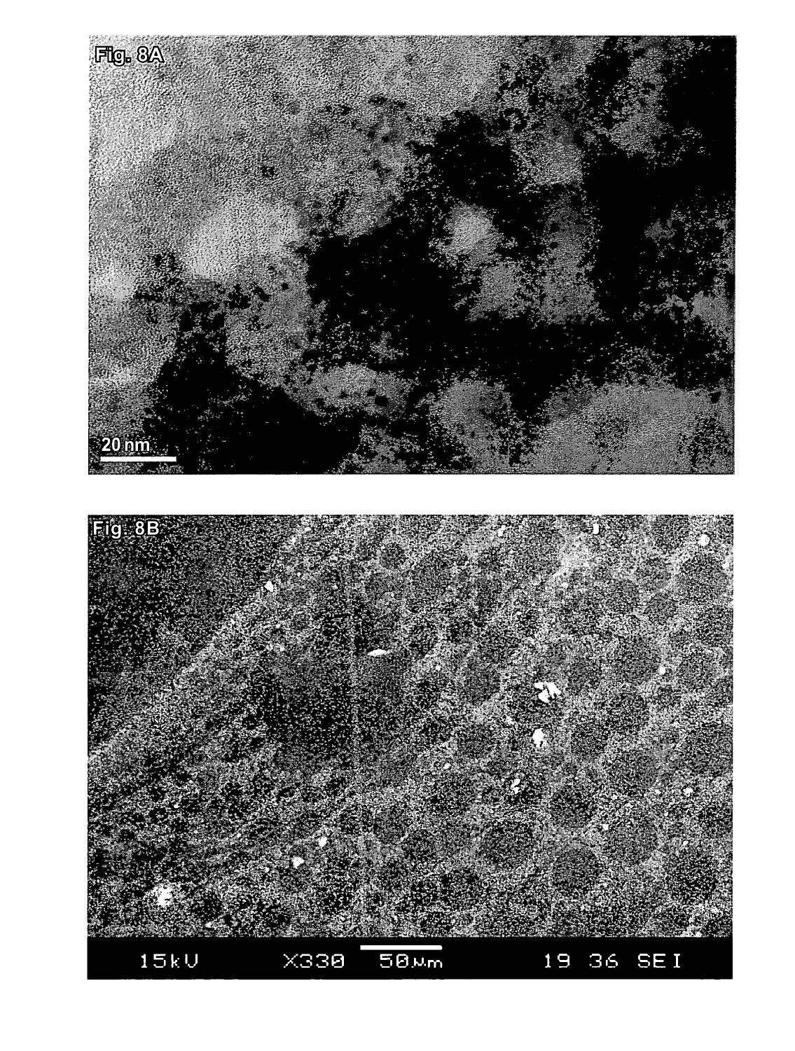

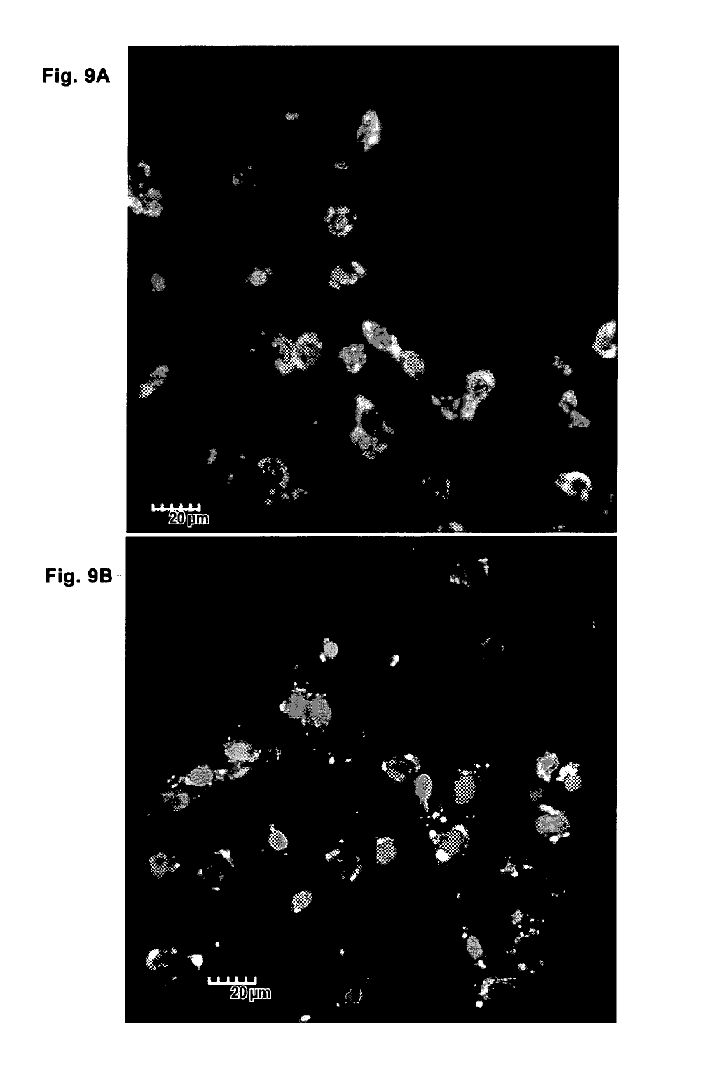

Tests with mammalian cancer cells (MCF-7 and C6) showed that the QD/polymer assemblies can be effectively internalized (FIG. 9). The accumulation of QDs in the cytoplasm of living cells is attributed to their selective distribution near the rough endoplasmic reticulum and the ribosomes when the QD/polymer assemblies enter the cytoplasm (FIG. 9b).

The invention illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by exemplary embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

1. A process of forming an amphiphilic polymer, the amphiphilic polymer comprising a hydrocarbon backbone, wherein the hydrocarbon backbone carries (i) —COOH side groups, (ii) first aliphatic moieties having a main chain of about 3 to about 20 carbon atoms and 0 to about 3 heteroatoms selected from the group N, O, S, Se and Si, and (iii) second aliphatic moieties having a copolymerisable group, wherein the second aliphatic moieties have a main chain of about 3 to about 80 carbon atoms and about 2 to about 40 heteroatoms selected from N and O, the process comprising reacting in a suitable solvent a maleic anhydride polymer of formula (I), 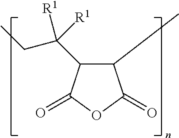
wherein n is an integer from about 10 to about 10000, and
R¹ is H or methyl,
with:
a monofunctional compound having an alkyl chain of about 3 to about 20 carbon atoms and 0 to about 2 heteroatoms selected from the group N, O, S, Se and Si, wherein the functional group of the monofunctional compound is capable of forming a linkage with an anhydride, and
an at least bifunctional compound having an alkyl chain of about 3 to about 80 carbon atoms and 0 to about 40 heteroatoms selected from N and O,
wherein one functional group of the at least bifunctional compound is capable of forming a linkage with an anhydride, and wherein another functional group of the at least bifunctional compound is copolymerisable,
wherein only the functional group of the at least bifunctional compound capable of forming a linkage with an anhydride is allowed to react with the maleic anhydride polymer of formula (I).

2. The process of claim 1, wherein the functional group of the monofunctional compound is one of an amino group, a hydroxyl group, a thiol group, a selenol group, a halogen, an ether group or a thioether group.

3. The process of claim 2, wherein the monofunctional compound has an alkyl chain of about 5 to about 15 carbon atoms and 0 to about 2 heteroatoms.

4. The process of claim 2, wherein the monofunctional compound is an alkylamine.

5. The process of claim 4, wherein the monofunctional compound is n-octylamine.

6. The process of claim 1, wherein the copolymerisable functional group of the at least bifunctional compound is one of an amino group, a hydroxyl group, and a group containing a terminal C═C bond, an allyl group, an allyl glycidyl ether group, an epoxide group, an oxetane group, an internal C═C bond, a terminal C≡C group, an internal C≡C group, a terminal coupled —C═C—C═C— group or a substituted derivative thereof

7. The process of claim 6, wherein the functional group containing a terminal C═C bond is one of a vinyl group and an acryl group.

8. The process of claim 1, wherein the functional group of the at least bifunctional compound that is capable of forming a linkage with an anhydride is different from the copolymerisable functional group thereof

9. The process of claim 1, wherein n is an integer from about 10 to about 400.

10. The process of claim 1, wherein n is 32.

11. The process of claim 1, wherein the at least bifunctional compound is a polyethyleneglycol or a diaminoalkyl-polyethyleneglycol.

12. The process of claim 11, wherein the polyethyleneglycol is PEG 600.

13. The process of claim 11, wherein the diaminoalkyl-polyethyleneglycol is diaminopropyl PEG.

14. The process of claim 11, wherein the diaminoalkyl-polyethyleneglycol is PEG(NH₂)₂ 1500.

15. The process of claim 1, wherein the at least bifunctional compound is one of a vinylic amine, a hydroxyl alkyl acrylic ester and an amino alkyl acrylic amide.

16. The process of claim 15, wherein the vinylic amine is 2-propen1-amine or aminopropyl vinyl ether.

17. The process of claim 1, wherein the process is carried out in the presence of a base.

18. The process of claim 17, wherein the base is a non nucleophilic base.

19. The process of claim 18, wherein the base is one of lithium diisopropylamide, lithium tetramethylpiperidide, diisopropylethyl amine (Hünig's base), 1,5-diazabicyclo[4.3.0]-non-5-ene, 1,8-diazabicyclo[5.4.0]undec-7-ene, a bis(trimethylsilyl)amide, a hexamethyldisilazane and bismesitylmagnesium.

20. A process of forming an amphiphilic polymer, the amphiphilic polymer comprising a hydrocarbon backbone, wherein the hydrocarbon backbone carries (i) —COOH side groups, (ii) first aliphatic moieties having a main chain of about 3 to about 20 carbon atoms and 0 to about 3 heteroatoms selected from the group N, O, S, Se and Si, and (iii) second aliphatic moieties having a copolymerisable group, wherein the second aliphatic moieties are defined by a poly(ethylene oxide) comprising chain,
the process comprising reacting in a suitable solvent a maleic anhydride polymer of formula (I), 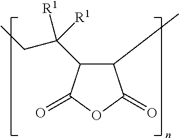
wherein n is an integer from about 10 to about 10000, and
R¹ is H or methyl,
with:
a monofunctional compound having an alkyl chain of about 3 to about 20 carbon atoms and 0 to about 2 heteroatoms selected from the group N, O, S, Se and Si, wherein the functional group of the monofunctional compound is capable of forming a linkage with an anhydride, and
a polyethyleneglycol or a diaminoalkyl-polyethyleneglycol,
wherein only one terminal group of the polyethyleneglycol or the diaminoalkyl-polyethyleneglycol is allowed to react with the maleic anhydride polymer of formula (I).

21-23. (canceled)

24. An amphiphilic polymer of the general formula (II): 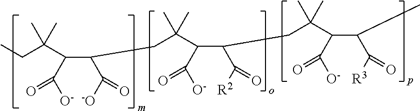
wherein each of m, o and p is an independently selected integer from about 3 to about 400 and wherein the sum of m+o+p is selected in the range from about 10 to about 10000,
R² is a first aliphatic moiety with a main chain of about of about 3 to about 20 carbon atoms and 0 to about 3 heteroatoms selected from the group N, O, S, Se and Si, and
R³ is a second aliphatic moiety with a main chain of about 3 to about 80 carbon atoms and 0 to about 40 heteroatoms selected from N and O,
wherein R³ has a copolymerisable group.

25-55. (canceled)

56. A method of forming a water-soluble nanocrystal, the method comprising:
(i) providing a nanocrystal in a suitable solvent,
(ii) contacting the nanocrystal with an amphiphilic polymer, the amphiphilic polymer comprising a hydrocarbon backbone, wherein the hydrocarbon backbone carries (i) polar side groups, (ii) first aliphatic moieties having a main chain of about 3 to about 20 carbon atoms and 0 to about 3 heteroatoms selected from the group N, O, S, Se and Si, and (iii) second aliphatic moieties having a main chain of about 3 to about 80 carbon atoms and 0 to about 40 heteroatoms selected from N and O, the second aliphatic moieties having a copolymerisable group, and
(iii) allowing non-covalent or covalent interaction between the amphiphilic polymer and the nanocrystal, thereby forming a water-soluble nanocrystal.

57-75. (canceled)

76. A water-soluble nanocrystal, the water-soluble nanocrystal comprising on its surface via non-covalent or covalent interaction an amphiphilic polymer according to claim 24.

77-97. (canceled)

98. A method of forming a polymer meshwork, the method comprising:
(i) providing an amphiphilic polymer, the amphiphilic polymer comprising a hydrocarbon backbone, wherein the hydrocarbon backbone carries (i) polar side groups, (ii) first aliphatic moieties having a main chain of about 3 to about 20 carbon atoms and 0 to about 3 heteroatoms selected from the group N, O, S, Se and Si, and (iii) second aliphatic moieties having a main chain of about 3 to about 80 carbon atoms and 0 to about 40 heteroatoms selected from N and O, the second aliphatic moieties having a copolymerisable group, and
(ii) allowing the copolymerisable group of the second aliphatic moieties of the amphiphilic polymer to be crosslinked.
